(19) United States
(12) Patent Application Publication
(10) Pub. No.: US 2012/0084135 A1
(43) Pub. Date: Apr. 5, 2012

(54) SYSTEM AND METHOD FOR TRACKING TRANSACTION RECORDS IN A NETWORK

(75) Inventors: Daniel NISSAN, Thornhill (CA); Corey GROSS, Maple (CA)

(73) Assignee: Smartslips Inc.

(21) Appl. No.: 12/896,442

(22) Filed: Oct. 1, 2010

(51) Int. Cl. G06Q 30/00

(52) U.S. Cl. 705/14.38

(57) ABSTRACT

The disclosure describes a database system and method for processing a transaction record of a transaction between a merchant and a user is provided. The system comprises a database and a server. The database stores and updates an account record and coupon records. The account record contains account data associated with the user and transaction data. The server provides update instructions for the account record to the database; communicates with a first terminal associated with the merchant to process the account record; builds the transaction record for the database using data relating to the transaction provided from the first terminal, the transaction record containing information relating to the transaction, the merchant and the customer; associates the transaction record with the transaction data in the account record; provides data relating to a selection of coupon records to the first terminal during a session relating to the transaction; and provides access to the account record to a requesting entity upon verification of access rights of the requesting entity to access the account record.

### FIELD OF THE DISCLOSURE

This disclosure relates to a method and system for processing, distributing and storing records relating to a transaction involving the sale and purchase of goods and/or services.

### BACKGROUND

Currently, merchants issue and print paper transaction receipts as a record of a completed (retail) transaction with a purchaser, when the purchaser completes a transaction for a particular good or service. In some instances, particularly in the case of purchases made over the Internet, transaction receipts are issued in the form of an e-mail. Transaction receipts are retained by purchasers for various reasons, including: to retain a proof-of-purchase record, possible return policy, for warranty coverage, to log purchasing activities, for expense reimbursements to various institutions (e.g. insurance companies, expense accounts), and for tax purposes (e.g. audits).

There are many problems associated with printed transaction receipts as a method of retaining and organizing transaction data. One problem is that paper receipts can easily be lost or destroyed. In addition, the organization of receipts, as well as their forwarding to interested parties, such as for expense reimbursement from an employer or insurance company, can take considerable time and effort. Printed transaction receipts are also susceptible to fraud.

There is a need to provide a system and method for processing receipts to address deficiencies in the prior art.

### SUMMARY OF THE DISCLOSURE

In a first aspect, a database system for processing a transaction record of a transaction between a merchant and a user is provided. The system comprises a database and a server. The database stores and updates an account record and coupon records. The account record contains account data associated with the user and transaction data. The server provides update instructions for the account record to the database; communicates with a first terminal associated with the merchant to process the account record; builds the transaction record for the database using data relating to the transaction provided from the first terminal, the transaction record containing information relating to the transaction, the merchant and the customer; associates the transaction record with the transaction data in the account record; provides data relating to a selection of coupon records to the first terminal during a session relating to the transaction; and provides access to the account record to a requesting entity upon verification of access rights of the requesting entity to access the account record.

In the database system, the data relating to the selection of coupon records may be provided to the first terminal upon a request received from the first terminal.

In the database system, the server may further: analyze the coupon records and the transaction in the database to identify the selection of coupon records; and provide the data relating to the selection of coupon records to the first terminal for presentation in a user interface on the first terminal.

In the database system, the coupon records may relate to a plurality of products or services from a plurality of merchants; and the server further may update the transaction record when a selected coupon is applied against the transaction to reflect a value of the selected coupon against the transaction; may update data in the database relating to the selected coupon to reflect application of the selected coupon against the transaction; and may analyze the coupon records to provide data relating to coupons that have been applied against transactions processed at the merchant.

In the database system, the server may further initiate a rebate process to process a credit value to the account data when a rebate transaction has been applied against the account.

In the database system, the rebate process may: update the transaction record when the rebate transaction has been completed to apply the credit value against the transaction record; and update data in the database relating to the rebate transaction to reflect application of the rebate transaction against the account data.

In the database system, the transaction record may include a version code to track a transaction version for the transaction.

In the database system, a copy of data associated with a receipt may be downloaded from the server for comparison with the server data.

In the database system, the server may further provide access to the transaction record in the database: to a second terminal when the second terminal provides authentication information about the user and the server authenticates the account record against the user; and to the first terminal when the merchant has been authenticated for access the transaction record.

In the database system, the transaction may be a purchase of an item by the customer from the merchant; and the server may update the transaction record with a change of status of the record when an authorized change request is received from the terminal.

In the database system, the change of status may be a return request of the item by the user to the merchant; and upon confirmation of completion of the return request the record may be updated to indicate that the item has been returned to the merchant.

In the database system, the server may further process a request for generating and sending a notification relating to the account record to an entity; the notification being sent upon satisfaction of a trigger condition for its transmission.

In the database system, the server may further update the transaction record to indicate that the transaction is a gift to a third party upon receiving a gift request relating to the transaction from a terminal connected to the server; the gift request may associate the transaction with a second user having a second account record in the database; and the server may update the transaction record to link the gift request between the account record and the second account record.

In the database system, the server may further: access the database and collect records relating to the account upon receiving a request from a requesting terminal; and transmit the records relating to the account to the requesting terminal.

In the database system, the server may further: update the transaction record to indicate that the transaction is an expense submission for processing by a third party upon receiving an expense submission request relating to the transaction from a terminal connected to the server; create an expense submission record relating to the transaction record and store the expense submission record in the database; and update a status field of the transaction record and the expense submission record upon receiving an update from the third party regarding a status of processing of the expense submission.

In the database system, access to data and transactions relating to the account may be restricted by a password.

In the database system, the database may further store and update data relating to a merchant account associated with the merchant. The server further may receive a request from a terminal associated with the merchant relating to the merchant account; determine whether the request from the merchant is authentic; and if the request from the merchant is authentic, then transmit the merchant records to the terminal associated with the merchant.

In other aspects various combinations of the above noted aspects are provided.

### BRIEF DESCRIPTION OF THE DRAWINGS

Embodiments of the present disclosure will now be described, by way of example only, with reference to the accompanying drawings, in which:

FIG. 1 is a schematic diagram of elements of a network where merchant terminals and user terminals are connected to a transaction server that processes transaction receipts according to an embodiment of the present disclosure;

FIG. 2 is a schematic diagram of elements of a merchant terminal and the transaction server of the network of FIG. 1;

FIG. 3 is a database entity relationship diagram of elements tracked by an embodiment of FIG. 1;

FIG. 4 is a set of flow charts for processes operating on the merchant terminal and the transaction server of FIG. 1 in creating and storing a transaction record for an exemplary purchase of an item by a customer at a merchant according to an embodiment;

FIG. 5 is a set of flow charts illustrating a return process of an embodiment of FIG. 1;

FIG. 6A-6B are a set of flow charts illustrating a coupon or rebate redemption process of an embodiment of FIG. 1;

FIG. 7 is a flow chart illustrating a gift transfer process of an embodiment of FIG. 1;

FIG. 8 is a flow chart illustrating an expense submission process of an embodiment of FIG. 1;

FIG. 9A is a flow chart illustrating assigning account permission attributions for an embodiment of FIG. 1;

FIG. 9B is a flow chart illustrating processing returns considering account permission attributions for an embodiment of FIG. 1;

FIGS. 10A-10H are block diagrams illustrating relationships among classes of database entities for an embodiment of FIG. 1; and

FIG. 11 is a diagram illustrating a receipt produced by an embodiment of FIG. 1.

### DETAILED DESCRIPTION OF THE EMBODIMENTS

The description which follows and the embodiments described therein are provided by way of illustration of an example or examples of particular embodiments of the principles of the present disclosure. These examples are provided for the purposes of explanation and not limitation of those principles and of the present disclosure. In the description which follows, like parts are marked throughout the specification and the drawings with the same respective reference numerals.

Briefly, an embodiment of the disclosure provides a system and method for disseminating paperless transaction receipts to participating users from participating merchants and providing a method and system for storing and tracking the same.

An embodiment provides a secure, efficient, intuitive, and cost-effective system and method for disseminating, authenticating, storing, organizing, managing, transferring, and redeeming records of commercial transactions. The transactions can cover any commercial activity, but one focus is on merchant/consumer and business to business transactions (including but not limited to manufacturer to wholesaler and wholesaler to retailer) for goods and services. An embodiment can replace or supplement the use of a traditional printed transaction receipt or invoice, which is currently used for the same purpose. This has a benefit of centralized record storage and processing and reduces reliance on paper-based records to effect transactions. An embodiment processes transactions for system user and third party users. System users include any entity that is tracked by the system, including merchants, organizations (e.g. employers, travel agencies, coupon clearing houses, etc.) and users. Users are generally individuals that are making transactions (e.g. purchases, returns, gifts) tracked by a system. Third party users are entities which do not have a formal connection to system users. Third party users may include external software package(s) that can receive and process data generated and tracked by an embodiment (e.g. Quicken software—trademark).

An aspect of an embodiment provides a secure system where a participating merchant provides a record of a transaction (e.g. a customer's purchase) in an electronic format from the merchant's point-of-sale (POS) terminal to a central server and database. Multiple merchants can provide records to the server and database. In one configuration for an embodiment, a merchant's POS terminal and its software is considered to be an external system to the embodiment's central server. In other embodiments one or more processing features of a merchant's POS terminal are provided by the central server or a related server.

At the merchant's POS terminal, a computer software extension (i.e. plug-in application) may provide the software code to generate, process and upload transaction data to the central server. The extension may be integrated with existing POS terminal software. Communications between the POS terminal and the central server may be through secure links. The data may be encrypted. The transaction record data may comprise any of the following items: a transaction identifier, a transaction date, a merchant identifier, a product identifier, a selling price of the product, an amount tendered, a payment method (e.g. cash, debit, credit, gift certificate, etc), tax(es) payable, any discount(s) applied, any discount identifier, any discount amount(s) received, a subtotal price amount, a total price amount, any merchant/manufacturer store warranty/return policies and rewards points information. A customer (i.e. a user) can access the system to review his/her transaction records stored in the system.

Transaction records are associated with an account. In an embodiment, the account tracks transactions of a purchaser. The account may be created by the purchaser (e.g. the user) or may be initiated to be created by an embodiment when the purchaser initiates a transaction. In an embodiment, each account tracked by the system is provided with a unique identifier, which may be a string of alphanumeric characters. An embodiment can track accounts held by individuals and by organizations. Organizations and users may hold multiple accounts.

Transactions processed by an embodiment for the account are associated with the account by the account identifier. The number of transaction records that may be associated with a particular account is limited only by storage constraints.

Associations may be made between accounts and different types of cards (e.g. relationships may be established among one or more credit cards, debit cards, points cards, loyalty cards, etc). A user may access the system via a so-called “convenience card”, which is a credit-card sized substrate having account data encoded thereon, via embossing, a magnetic strip, a smart chip, or a barcode. The card provides a convenient interface for users to access identification numbers of accounts for which the electronic transaction receipts can be associated. Radio Frequency Identification (RFID) technologies may be used to encode information on a convenience card.

A user may also access the system via an interface through portable electronic devices (PEDs), such as a smart phone and a personal data assistant (PDA). Such devices may also store one or more identification numbers for the system. Such devices may have access applications to access the central server and/or the data. A PED can be used to access identification numbers of a user, to electronically transfer the user account number to the merchant POS terminal directly.

Another aspect of an embodiment provides an interface for a user to access data held at the central server relating to a particular account from remote location(s). Additional transaction data continuity is provided. The reliance on paper-based (receipt) records from prior art systems is reduced. Remote, local and on-demand access, updates, and printing of transaction records is provided. The interface provides an access point to request and retrieve records in the account. The records may be a particular transaction or a group of transactions. The records may include an electronic image of a merchant's transaction receipt. The interface provides data analysis tools, such as filters, a search toolbar, data sorting tools (e.g. color-coding/graphic icon schemes for records), data organizing tools (e.g. folder that organize records based on date, merchant, transaction type—e.g. food, gas, electronic stores, etc.), and tools for a web-based access point or a PED-based access point. Summary analysis and purchase reports can be generated based on transaction records of a user. The reports can provide charts and graphs on any number of metrics, such as habits based on purchase methods, product types, merchant types, etc. An additional feature allows the user to attach personalized comments/notes to particular transaction receipts in the account.

An aspect of an embodiment allows a user to download selected transaction data from the system into third party accounting and financial management software (e.g. Quicken—trademark). The downloaded data may relate to any selected transaction. The data may be provided in a format suitable for storage on a local computer for use by such third party software packages. Third party software packages may include those offered as software as a service (SaaS). The data may include certificates of authenticity and offline receipts. Offline receipts are receipts that are accessible without connection to the system and may include receipts downloaded and stored locally.

Additional user maintenance functions are provided in the system to allow transferring records between accounts, redeeming loyalty points associated with an account, associating third-party loyalty cards to an account, paying balances for an account, etc.

The system provides a secure system consisting of a user interface such as, but not limited to, a secure account-based internet website or PED web-based application, which registered users utilize for the purpose of accessing the collection of transaction receipts for which that user has been granted access. Access to the website may be secured by using secure protocols, such as secure hypertext transfer protocol, and by using password protected user accounts. Only users who are given privileged status to accounts and receipts may access records of receipts tracked by an embodiment. Users may be directly associated to accounts. Users may have privileges relating to organizations that have associations with accounts thereby having indirect associations with accounts.

The system authenticates merchants that request data from the server or submit data to the server. Access to information by a merchant may be limited by the system. For example, a merchant may only be able to access information that it has submitted or information that was submitted by a related merchant or information to which a third party has allowed the merchant to access. Communication between the merchant and the system servers may take place using secure authentic channels such as secure socket layer (SSL).

As part of an authentication process for receipt data, a merchant may attach a digital signature to receipt data that it submits to the system. This signature may be verified before committing the receipt data into the database. The signature may be stored in the system so that at a later time the signature can be used to confirm the receipt's authenticity. The structure of the information that is signed may be well-defined to allow third parties to verify the authenticity of receipts.

Data for the receipts may be stored in any suitable format offline or in databases accessible by the system. The data may be encoded to allow direct formatting in markup languages (such as HTML and yml). Data may also be retrieved and converted to a format providing any required data for signature verification if required.

The system may use public key cryptography, where for a given transaction or session, the server has the public key and the private key is held only by the merchants. The server may store the merchant public key so that the merchant does not have to resend the key on every request. Even if server security is compromised, the authenticity of the receipts stored in the system remains intact. Generally, the keys may be signed by a certificate authority to prove authenticity of the key. Merchants may have their own private keys so that if the security of any one merchant is compromised, only receipts issued by that merchant may be compromised. Keys may be used for short periods of time to further reduce impact of discovery of private keys.

Certificate data provides information required to authenticate a receipt for the system. A certificate may comprise one or more of: a digital signature; a message digest; a label identifying the cryptographic key that is to be used in the verification process; a label describing the signature algorithm used; and an encoding format identifier that may identify a formatter that can translate receipt data into well-formatted, reproducible data used during electronic signing. Certificates may be provided to a user automatically upon request. Public keys stored by the system may be accessible by users of the system to allow independent verification of signatures on offline receipts.

An embodiment also tracks versions of instances of data. For example, version data may be associated with receipts. A version tag can be associated with a receipt, where the version tag includes data relating to a ‘last update time’. As such, time data may be used to compare receipt information presented to the system (e.g. during a refund transaction) against the current information stored in the system. For example, the version data in the system may be used to validate a copy of a receipt. The copy of the receipt may be considered to be an “offline” copy as the ‘online’ data reflects the “true” data for the receipt. In one embodiment, “offline data” may be used as follows. When a receipt is downloaded, it can include the version tag data associated with the underlying purchase record stored in the system. The version tag on the offline receipt may be compared to the version tag of the receipt on the server. If the version tags match, the offline receipt can be considered to be a valid, current representation of the transaction record. If the tags do not match then the offline receipt does not reflect the authentic version of the receipt data.

An embodiment provides a registration system for merchants and users. Merchants and the server may pre-exchange cryptographic public keys. Merchant-server communications may be secured and authenticated without using secure protocols such as SSL. In one method, a merchant may select a one-time symmetric key and then encrypt it with a salt (namely a series of random bits that are used as one of the inputs to a key derivation function), merchant identification, and other values, using the server's public key. Subsequent communications for an individual request may use the generated key. Presuming that only the server is able to decrypt the message, privacy between the authenticated server and the merchant is achieved. The merchant may additionally sign the data, which may be verifiable by the server, which assures the server that the merchant is authentic.

These security measures provide a user with confidence that transaction data stored in his account(s) is authentic and verified and provide a merchant with confidence that forged (paper/data) transaction records have not/will not be accepted into the system.

The system also provides a series of notification messages to devices associated with users and merchants. A notification may be generated upon predetermined triggering events. The identification of such triggering events may be determined by an embodiment by analysis of the transaction data. For example, a notification may be generated for a user for his associated device or email address indicating an approaching expiry date for a warranty, rebate offer, coupon, or transaction receipt return policy associated with a particular transaction record. The system allows a user to customize the types, frequency and levels of details for notifications. Other notification triggers may include: issuance of a new receipt to an account, a new return, a submission for rebate or reimbursement (e.g. an expense reimbursement) and the initiating of a gift transaction. Processing of an action, at the request of the user, by the web server, application server, or other component may be considered to be an event for which notification may be scheduled. Sub-processes within an action having many processes may also satisfy notification trigger criteria. For example, when issuing a receipt, several discrete processes are provided to review a transaction, process payment procedures and generate the receipt. One process may be coupon acceptance, validation and processing. The coupon process (or sub-processes within same) may include processes to trigger a notification.

An embodiment provides a graphical user interface (GUI) for users to manage notification requests to select and tailor characteristics of a particular notification. Permission(s) may be required to access the GUI. The embodiment allows for different types of notifications to be generated (e.g. voice mail, text message, email, web services call, and others). A notification dispatch component monitors events and processes and controls how and when notification(s) are generated and sent. The timing of the notification can be controlled. For example, the notification dispatch component may signal that an event is occurring either before, during, or after performing an action. In other embodiments other user interfaces may be provided including command line interfaces and other non-graphical user interfaces. Other interfaces may be provided through application programming interfaces (APIs) and web-based interfaces. These other interfaces provide data and connectivity interfaces at a system level to allow third party systems and/or software to communicate with the processing system and the data.

In generating a notification, the notification dispatch component may be provided details about the particular event. For example, on a receipt issuance, a messaging signal to the notification component about an event may include: the event type (receipt creation), issuer data, receiving account data, transaction details, or summary data. The processes executed in the dispatch component in response to the signal may be carried out synchronously or asynchronously with respect to the triggering process and may be a process running on the same server or on a separate server within the system. The notification component may analyze details of the event and may be able to determine one or more possible parties to be notified (“notifies”). For example, if a coupon has been used during a purchase, the system attempts to identify potential notifies among those on the notification list for both the coupon issuer and the account. During a return process the system may determine that a receipt has previously been used in a submission process by checking the transactions history. This history includes the submission receiver who may request notification of the return event. If notifies have been registered for the event, the system may evaluate whether the details meet certain criteria. For example, a manager wishes to be notified by text message about transactions for an account that exceeds a certain dollar amount. If the criteria have been met, the notification is dispatched. Notifications may also be scheduled for delivery at a later time. These may include scheduling notifications such as warranty or return policy expiry.

Fields for transactions records stored in the system may be standardized, which allows different merchants to provide structured yet extensible transactions records. This also may facilitate efficient use of storage facilities for a relational database. However, from the standardized fields of records, a merchant may create customized receipt layouts to display the line-item transaction data, on a graphical user interface used by a user. The merchant may store extra less-uniform detail fields about a transaction and those extra details may be displayed on the customized information display layout. The templates can be created by the merchant and uploaded to the system. Templates may be edited on a website that is accessed by users on the merchants' behalf. The template code may be executed in a secure environment so that the template code does not breach system security or compromise system stability. This can be accomplished through the use of a template engine. When a user selects a receipt to be viewed, the system passes the receipt data and the required template definition to the template engine. The template engine produces the final display. The templates are not limited to displaying information graphically to the user. Templates can be created to transform data into more machine friendly formats like those that are readable by accounting software. An example would be a template for an XML receipt format. A default template may be provided which displays common receipt information. Merchants may have multiple templates. Each template has a validity period. Primarily, the receipt's transaction date will determine the template to be used. This allows the merchant to update the layout for newer receipts without regard for compatibility with past receipt data. Additionally, receipts may specify an identifier of the desired template for the transaction allowing receipts issued in the same period to use different templates.

One feature of an embodiment provides an electronic system and method for processing product returns (i.e. redemption of a proof-of-purchase). When an item is returned to the merchant, in lieu of (or in addition to) presenting a printed-paper receipt, the return action may be processed using records in the system. At the merchant's terminal, the merchant accesses the server and conducts a search of the accounts specified by the user's identification number to access a list of the purchases made at that merchant for the accounts. Once the corresponding transaction record for the item is located, the merchant verifies that the item is indeed authorized for return by the appropriate party. If the item has not been involved in a rebate or reimbursement it may be eligible for return. The merchant may process the return and send the return information to the system. The system may store the return transaction data and adjustments may be made to the original record for the transaction. Adjustments may include adjustments to total price, and changing a state of the transaction to “returned by purchaser.” The system retains enough data to reconstruct the original receipt and will still have the ability to verify the certificate of authenticity. A user may select a particular item intended for return using a web, a PED or another interface. The item may be “flagged” for return so that the merchant can more efficiently identify and retrieve the information about the transaction during the return process.

When a user accesses his account via a website user interface or PED-based application herein, several record processing activities can be provided. Such activities relate to returns, gift processing, coupon redemptions, rebate redemptions, permissions to accounts, and transaction record submission requests. All these processes are provided through a centralized system that can be accessed through a merchant's terminal or a user's terminal. Different data and levels of data are provided to the requesting party depending on its level of access permissions attributed to it. Exemplary activities are described below.

A record may be designated as a “gift,” which can be forwarded from one account to another account. If a record is being sent as a gift to another user, then the records for that receiving user are updated pending his acceptance of the record as a gift. Both users will have access to the electronic transaction receipt—the donor of the gift retains a record of the purchase for accounting purposes while the gift recipient may use the electronic receipt for proof-of-purchase purposes (i.e. authorizing returns or redeeming rebates). An embodiment allows individual items or receipts or bundles of items and receipts to be transferred as a gift or gift set.

A record may be forwarded to a third party for further processing. In one embodiment, when intending to forward a record, a user marks the transaction record to be a “submission” record. The “submission” record label is then used to identify the record as a forwarded record. The “submission” record may then be transmitted electronically through the network to processing systems for one or more third party organizations (e.g. insurance companies, revenue agencies, and the user's employer). These third party processing systems may have an option to accept or reject the submission (per a verification routine for the submission record or its related owner). Upon acceptance of the submission record, the recipient may view the submission record and use the data contained therein for its processing purposes. For example, the data may be used as a proof of purchase or for expense reports.

An embodiment also provides processing of electronic “coupons” against transaction records, where a user can activate and redeem a product coupon against a transaction record. The coupon, once associated with the record, may then be applied immediately at the time of the transaction through the merchant's POS terminal. For example, when a user is browsing through an online system, he may be presented with a set of electronic coupons. Additional coupons may have previously been associated with the user's account. At the website, the user may select one or more coupons from the website and have them associated with his account. As such, the user may have a selection of coupons at his disposal (e.g. the coupons from the website and previously associated coupons) in his account. Later, when the user is making a personal visit to a merchant and is making a purchase, at the merchant's POS terminal, when the user's account is accessed, the coupons associated with his account may be displayed. The user may then be provided with the option of selecting and activating one or more of the coupons. The POS system may then apply the activated coupons against the purchase. The receipt item detail that is sent to the server can include any coupon processing details. A coupon can relate to any product or service that is offered from any merchant or manufacturer. For the sake of convenience, and not limitation, the term “merchant” includes an entity providing retail sales or services directly to a user and an entity providing sales or services to a merchant for sale to a user. Here, for example, a manufacturer is also a merchant. Coupons may be pre-selected or may be presented to the user at any time during the processing of a transaction. For example, as a purchase transaction is being processed, an embodiment may analyze the transaction to identify the product being purchased and then execute a query to a coupon database to determine if there is a coupon that relates to the transaction. A determination may be made based on the item being purchased, either as an exact match or a category match involving a product offered by the coupon offeror. If a coupon does match, then a coupon offering process may generate and send a message to the POS where the transaction is being completed to present data relating to the coupon in a GUI on the first terminal. Alternatively or additionally, a set of coupons may be provided to the first terminal without analysis of the current transaction. The data relating to the coupons may be provided upon a request initiated from the POS or may be provided when an embodiment determines that a transaction is being processed by the POS.

An embodiment also provides processing of electronic rebates against transaction records. A rebate is provided by a merchant or manufacturer (or other organization) against a specific item. Generally, processing rebates is a post-transaction event that is a separate transaction between the purchaser and the rebate offeror. The rebate may be offered by entities that include the merchant, the manufacturer of the item and other entities (e.g. government program rebates). In many instances, the merchant is not involved with the processing of a rebate. As the processing of a rebate more directly involves analysis of a transaction record, the central system of an embodiment processes a rebate redemption.

As a transaction is provided to the system, an embodiment can scan the transaction for details and attempt to identify a list of potentially applicable rebates from a rebate database. Once a set of potential rebates are identified, a list is presented at the POS terminal where the transaction is being completed. Additionally or alternatively, the list may be accessible through a website's GUI, a GUI on a PED or through a POS terminal. To process a rebate, the user selects the rebate action with the proof-of-purchase information for the associated transaction record. Then a rebate process request can be generated and a rebate package information can be submitted to the entity offering the rebate for further processing. The selected rebate becomes a data record for the system and may be processed electronically. The rebate record may be associated with the transaction record. Processing of submitted rebates may be conducted in a batch format at set time(s) or at the time of submission of a rebate request. Rebate notifications may be generated and sent to the user associated with the transaction record.

An embodiment also provides facilities for third party messages to be generated on a GUI while the user is accessing the system. The third party messages may include advertisements. Advertisements may be targeted at the user based on an analysis of the current transaction record, recent activities of the user, demographics, and other factors. Generation of the advertisements may be selectively triggered by an event, which may be initiated by the user (e.g. through an access of a detailed line-item image of a transaction receipt) or by the system.

The system also provides a set of permissions to be associated with an account. Account owners have full permissions to the account. Other users may be assigned permissions (including but not limited to: account viewer, account purchaser, account manager, etc.). An account owner (namely, a user) may receive notifications, analysis and reports of any users granted permission under the owner's account. The report(s) may be provided in a log that tracks user actions on an account. The reports provide a measure of security, allowing the user to review the log to see whether changes were made to the account, by whom, when, and where. Access may also be granted on an organizational basis. Users may be associated with organizations and hold for example “manage all accounts” permissions. Those users may then have permissions relating to account management for accounts related to the organization.

Integration of user identification numbers is provided for third party loyalty cards, credit cards and bank cards. A credit card, loyalty card, bank card, or other account card which is associated with a user's account, may be used to direct transaction record data to the related account. An embodiment may utilize a shortened or hashed version of the card information, thereby enabling an embodiment to operate without storing a complete record of sensitive credit card data. This enhances data privacy if system or account security is compromised. The system searches a list of card numbers (e.g. through a hash map) in order to find the identifier of the corresponding account.

With aspects of an embodiment described, further detail is provided on specific operations and transactions processed by an embodiment.

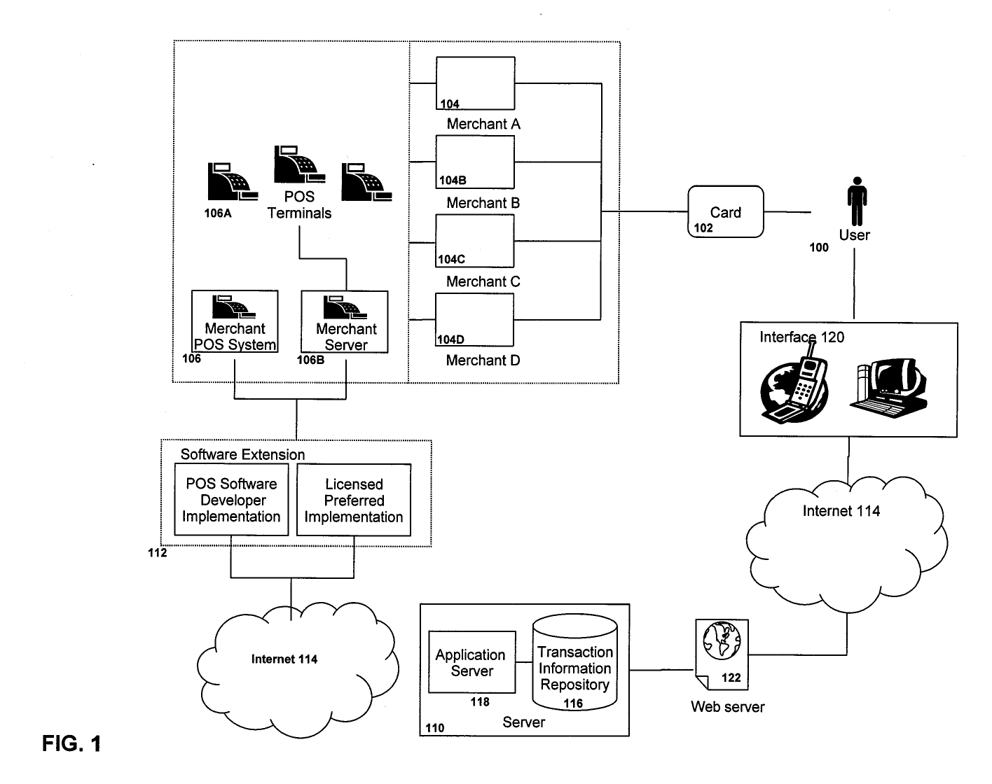

Referring to FIG. 1, an environment is shown where a merchant-consumer transaction is being conducted using an embodiment. Typically, a transaction involves the consumer presenting a desired good (or service) to the merchant vendor, submission of payment by the user (via cash, credit card, debit, coupon, etc.), validation of the payment by the merchant, and printing of a transaction receipt to provide a record of the purchase. An embodiment provides an automated, electronic system for the stage of printing a transaction receipt.

For the purchase of the good at the participating merchant, purchaser 100 presents his unique identification number (herein embodied in plastic card 102), to merchant 104, which may be any retailer, such as retail store clerks, unmanned payment stations (i.e. gas pumps, supermarket checkouts), and e-commerce websites. There may be several locations for merchant 104 (shown as merchant 104b-d). Merchant 104 scans card 102 to access its encoded account information (through a barcode, magnetic strip or smart chip, etc.) at POS terminal 106. Alternatively, the user may provide the identification number to the clerk for manual entry into POS terminal 106. POS terminal 106 packages the transaction data associated with the purchase and user identification number into a format for transmission to server 110. A self-contained merchant POS system 106 may be provided. Alternatively, a POS system 106 may consist of POS terminal 106A connected with merchant server 106B. In POS terminal 106 or merchant server 106B, software extension 112 provides commands to its processor (not shown) to communicate with system server 110. Extension 112 may receive data relating to the purchaser 100′s account and the transaction being executed from software on POS 106 to generate a data transmission package to be sent via Internet 114 to server 110. At server 110, transaction records from merchant 104 are received and stored in transaction information repository (central database) 116. Application server 118 handles merchant requests and accesses the database server 116. Server 110 allows for different access and read/write privileges to a requesting party (e.g. the merchant, the purchaser or a third party) depending on authorizations provided to that party. Server 110 may be connected to terminal 106 and interface 120 through Internet 114. Web server 122 may be provided as an interface to access server 110 by any of terminals 106 and/or 120.

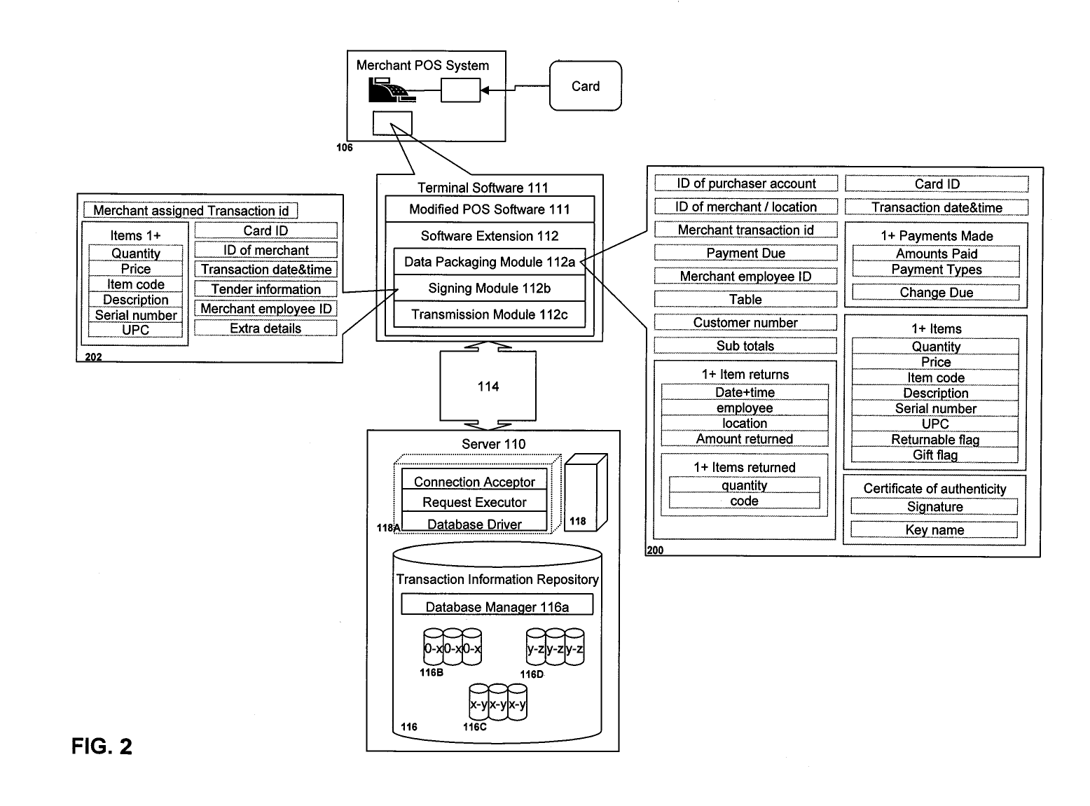

Referring to FIG. 2, Merchant POS system 106 and software 111 accesses server 110 containing database 116 through software extension 112. Extension 112 has data packaging module 112a, signing module 112b and transmission module 112c. Data packaging module 112a builds exemplary data packet 200 relating to the purchase information containing data fields of various information relating to the purchased products, the user and the merchant. Signing module 112b builds transaction certificate based on exemplary transaction data subset 202 relating to the digital signature process. Data packets 200 and 202 are bundled and transmitted to server 118 by transmission module 112c. Data may be sent over a secure link through Internet 114 to server 118. The transmission module may pre-select an application server with which to connect. A designated set of preferred servers may be specified in a configuration file. There may be proxy servers at server 110 to help select and distribute load over the application servers. There may be different extensions provided based on the state of development of the software in extension 112 or in merchant system 106. Extension 112 may be a component of the main software executable of terminal 106 or as part of a separate component possibly running on a separate machine.

Server 110 has database 116 for storing data received from transmission module 112c. Server 110 includes application servers 118 to process input and output data transaction requests, such as requests received from transmission module 112c. Server 110 may include many application servers 118 to provide scale out replication to support a higher volume of requests. Module 118 may include a connection acceptor to evaluate and accept a communication connection for server 110 to external systems 106, and a request executor to process transaction requests received from external sources 106.

Database 116 includes processes to parse, store and retrieve data stored therein. Database manager 116a provides a series of applications to update and retrieve data from database 116 and to perform administrative functions such as monitoring and controlling individual database servers.

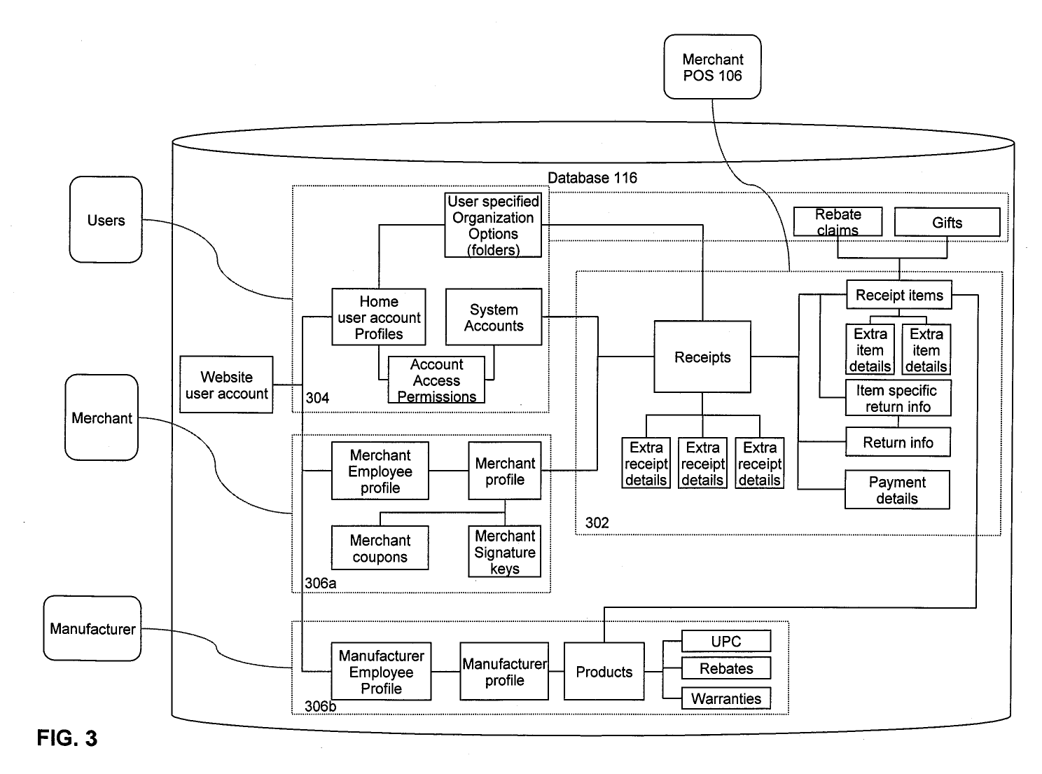

Referring to FIG. 3, exemplary details of database 116 are provided. Database 116 may be a relational database comprising tables and table relationships relating to transactions processed by an embodiment. Selected manufacturers and merchants may access and update database 116 to disseminate advertisement, rebate offers, warranty offers, and information and coupon offers to users 100. Selected users may access the database to determine a course of action for their particular accounts. Information is updated to database 116 via remote terminals, such as a merchant POS or a user's terminal (e.g. at home).

Further details are provided on exemplary data structures for records processed by an embodiment. In FIG. 3, an exemplary database relationship diagram is shown. The series of figures labeled 10 show database entities in the form of object classes, which may have a corresponding table in the database. Information that may be generated on a traditional paper receipt may be stored as transaction data within the database. Fields within tables may be common among merchants. Fields may be customized and used according to requirements of merchants.

An embodiment has four main data entities: receipts, users, accounts and organizations. Each is discussed in turn.

A receipt is an elemental record tracked by an embodiment. Tables outlined by 302 and shown in 10C show exemplary linked tables relating to a receipt. A receipt is created when a transaction (e.g. purchase an item) is made at a merchant who provides details regarding the transaction. A receipt includes line-item details and auxiliary information related to storing data relating to the transaction, such as item identification (stock keeping unit number, inventory identification number), quantity, date, and description of item etc. Receipt data includes the purchaser information by way of an identification (ID) field pointing to a particular account.

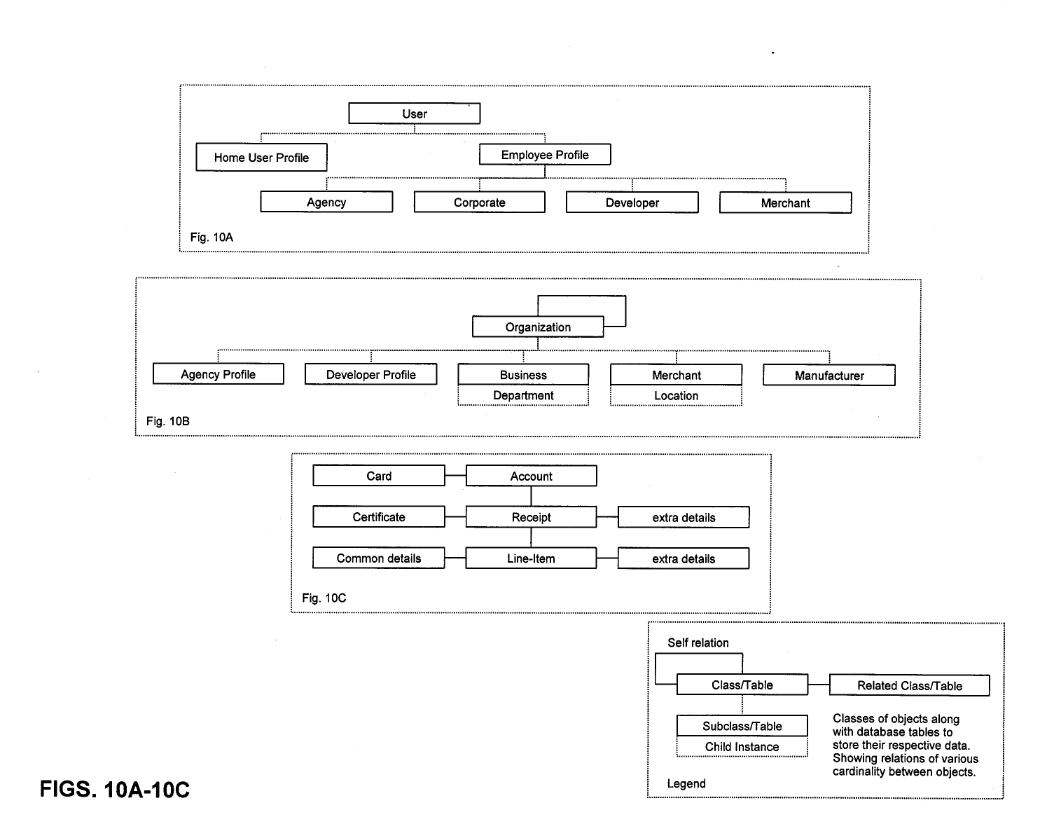

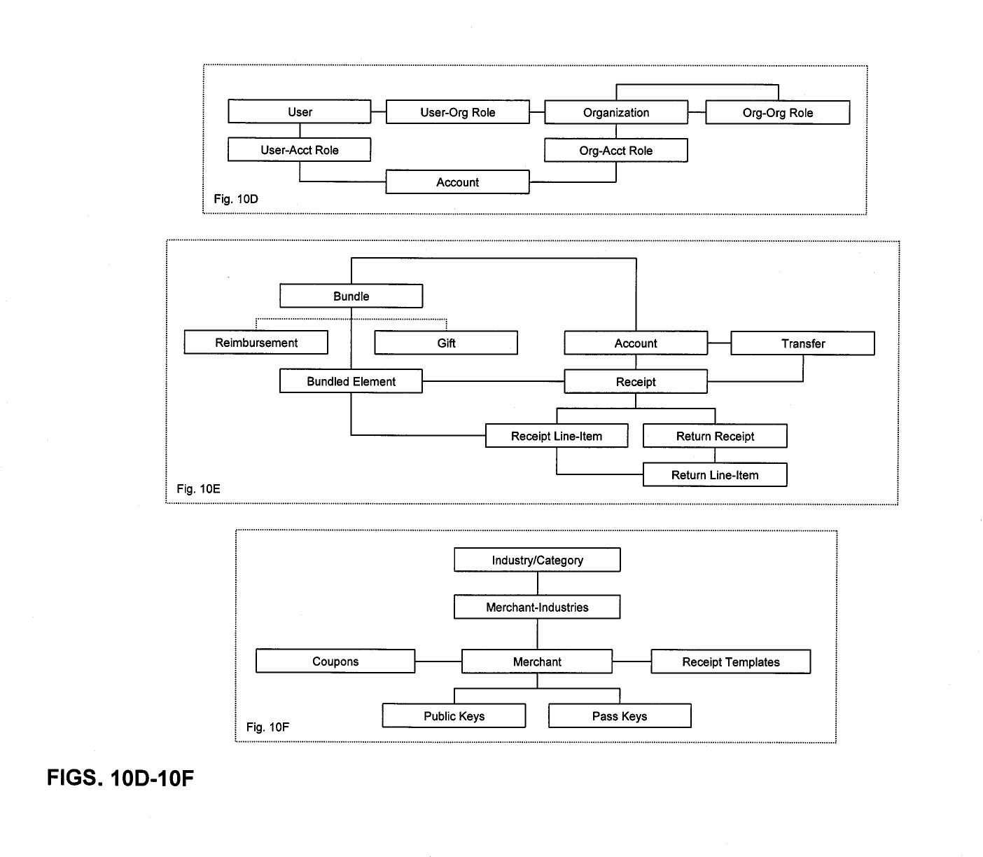

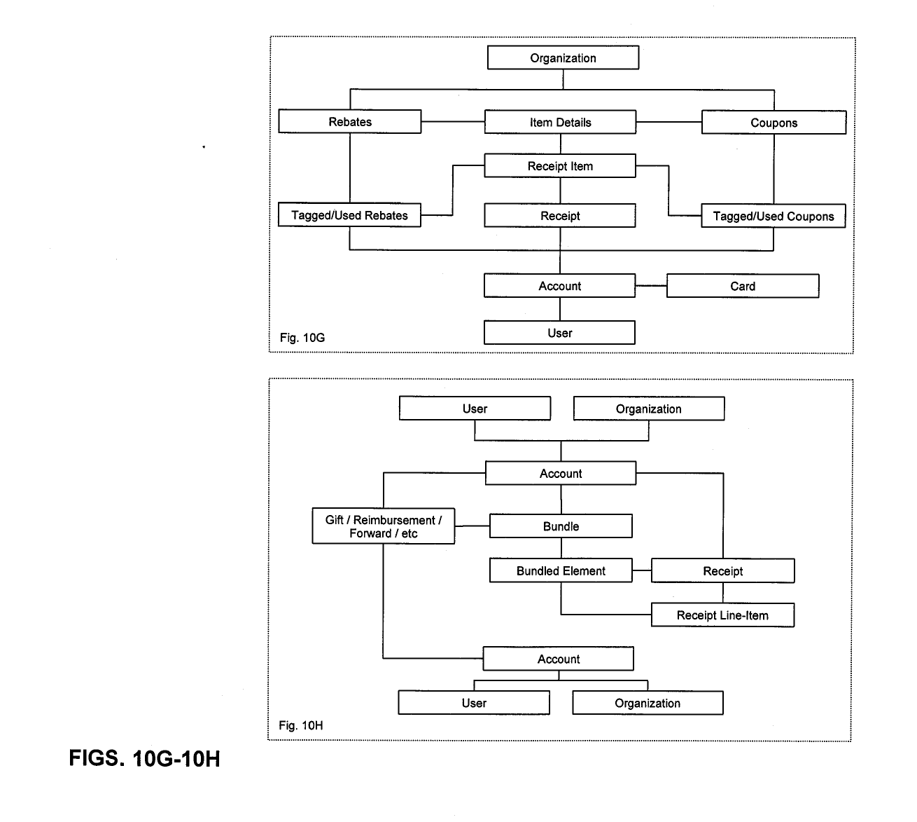

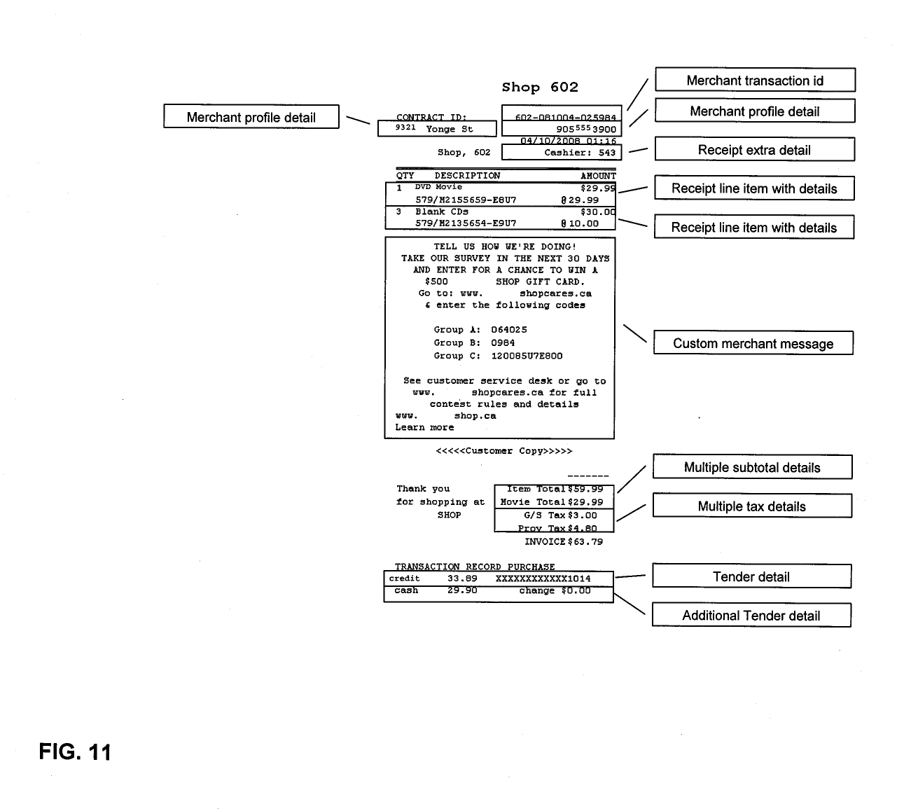

A user is associated with a receipt. Tables outlined by 304 show exemplary linked records relating to a user and related accounts. The user is a person that can initiate a transaction (purchaser) reflected in the receipt using the embodiment. A user object in the system relates to access credentials for individuals to log into the system. User profile information related to the user, e.g. full name, address, occupation, contact information, etc. is stored by an embodiment. FIG. 10A shows user subtypes with possible corresponding profile information. An embodiment allows restrictions and authorizations to be provided by a user on data relating to his account/organization/receipts tracked by an embodiment. Some functions, where such data is requested to be modified, require an authorization to be provided to the user to execute the function. Authorization may be provided from another user (e.g. the supervisor of the user) or through entry of an authorization code. Also, express default permissions may be provided by an embodiment. Permissions relate to authorizations granted to the entities to perform modifications.

An account, shown in FIG. 3 part 304, is tied closely to a user and receipts. An account is created for a user to track a set of related receipts. Accounts may also be associated with organizations. Information related to the account, e.g. name of account, associated users and organizations, etc. is stored by an embodiment.

An organization is an entity that can group different users together. Exemplary organizations include merchants, employers, departments, agencies, software developers (system integrators), cities and families, etc. Sub-groups can be provided for organizations (e.g. accounting departments, relatives in a specific city, etc.). As depicted in FIG. 10B, information about the organization, e.g. name of organization, description of organization, etc. is stored by an embodiment as profile information. An organization may also have parent-child relationships to other organizations, thereby providing a hierarchy where an individual business may have departments or location branches as child organization entities, allowing further advanced access control and grouping options. Audit departments may require access across an organization and its child entities, whereas managers may only need access to a certain part of the organization's data, which can be grouped by office branch or department and be related to the parent organization entity. In an embodiment, organizations may be associated with one or more other organizations allowing further advanced access control, for example: system integrator organizations may have access to merchant organization data to perform functions on the merchant's behalf.

As shown in FIG. 10B, a merchant is one type of organization. Referring to FIG. 10F, a merchant has and manages multiple receipt view templates, client authentication passkeys, receipt authentication public keys, and auxiliary services that can be performed by the servers such as coupons and rebates. Fields 306a show exemplary linked records relating to a merchant. Sub-data within a merchant includes an industry, size, geography, and other data. This allows filtering of purchase data through sub-group data. A merchant organization may issue receipts for sale transactions between the merchant and customers. Merchants have other related maintenance functions and corresponding data objects.

Referring to FIG. 10B, other exemplary types of organization include: a manufacturer of the products; a distributor of the products; a support organization, such as an application developer who distributes POS software relating to an embodiment to merchants; a service provider that uses an embodiment to track purchases and expenses for (third-party) employees; accounting firms; law firms; revenue agencies; insurance agencies; and other organizations which receive or process submissions of proof of purchase by other users of the system. Table 306b show exemplary linked records relating to a manufacturer. Hierarchies of organizations can be maintained in the system, where (sub) organizations may be associated to a parent organization. This allows links to be established between different entities. For example, merchants and merchant locations may be linked together in a hierarchy. These associations may be useful in processing certain transactions, such as returns. A merchant's return policy may allow returns at any of its store locations or may have restricted returns for certain products.

Referring to FIG. 10D, an embodiment allows associations to be made among receipts, users, accounts, and organizations. Users may be associated with multiple organizations. Users and organizations may be associated with multiple accounts.

In an embodiment, database 116 containing data relating to receipts, users, accounts, and organizations, may be stored and tracked in a relational database management system (RDBMS). Any database architecture and datatypes may be used in place of this RDBMS, such as series of flat text files storing complete information about a particular transaction with multiple receipts stored in the same file. This complete information may include any subsequent operations relating to that transaction such as returns. To prevent scattering of receipt data, transaction data for an account can be assigned an exclusive file or set of files. An indexing system can be used to accelerate sorting and filtering of the information contained in those files. Each account can have various indices for the different data fields. The indexing system may be implemented using a RDBMS. Accounts may also store lists of receipts that they are related to, but that are associated with other accounts. Such lists may include records of receipts that have been submitted for reimbursement. These lists may be used to augment the indexing system.

Referring to records in table group 302 (FIG. 3) and account organization chart in FIG. 10C, other information relating to a receipt, such as identification card used, transaction time, merchant and location, and amount paid may be stored in fields of the receipt table. Other ancillary data may be stored together as a set of key-value pairs or all keys then all values in a single or multiple large object types in the same table or alternatively in an auxiliary table or even outside of the database in an indexed file. Examples of ancillary data include salesperson identification, device, gas pump number, department, tax information, and tender data (if relevant). Auxiliary tables may be used to store multiple composite data, such as one or many tender details related to a single receipt record. Having specific fields would be useful when indexing and sorting is expected for that field or when that field is common to the extent that it saves space.

As previously noted, a receipt for an item may contain information relating to quantity, line total, and description of the line item. Items may be keyed based on receipt key and using line numbers for uniqueness among other item records for the same receipt. The receipt may also track a product code, discount information, unit price, and department. It is expected that a description of an item sold at a store will not be changed frequently. As such, a database may store the item information once in an item information table that could store unit price, tax information, description, and others in an attempt to normalize the data. The receipt may provide a pointer to the item information record. Table A provides a list of exemplary fields in a receipt record for table group 302.

TABLE A

| Field | Description |
|---|---|
| Account Identification | Provides the account of the user associated with the receipt |
| Merchant Identification | Provides the name of the merchant from where the item was |
| | purchased. There may be multiple merchants associated with the |
| | receipt. For example, two merchant IDs may be used to track the |
| | parent merchant and the location merchant. |
| Amount | Price for the transaction |
| Quantity | Total quantity of an item |
| Subtotal(s) | The subtotal can record a description of the subtotal and the subtotal |
| | amount, for example, subtotals for grocery, bakery, and meat items |
| | for grocery purchases as well as subtotals for food and liquor for a |
| | restaurant receipt. |
| Tax 1 | A first tax applied (e.g. goods and services tax, federal tax) |
| Tax 2 | A second tax applied (e.g. state tax, harmonized tax) |
| Currency | Tracks the currency of the originating transaction |
| Type of Payment | Tracks how the item was purchased (e.g. cash, cheque, VISA, debit), |
| | change returned, cash-back offered, etc. Electronic payment details |
| | may be tracked for a debit or credit transaction card number, |
| | processing suffix, expiry, cardholder name, electronic payment |
| | transaction authorization number, and reference number. |
| Coupon | Tracks any coupons applied against the purchase |
| Gift Cards | Tracks any value of gift cards applied against the purchase |
| Discount Applied | Discounts noting the description of the discount, and discount in |
| | percent or absolute amount may be kept. |
| Total Paid | The total reflects the amount of funds the purchaser applied for the |
| | transaction taking into account the different tendered amounts and |
| | any returns made that pertain to that transaction. |
| Loyalty Program | Any “points” program awarded on this transaction and/or across |
| | multiple transactions may be tracked against the loyalty program |
| | data. |
| Transaction ID | A merchant may assign a unique transaction identifier allowing the |
| | merchant's transaction tracking system to quickly identify this record. |
| Terminal ID | The ID of the terminal used when processing the transaction. It may |
| | be a cash register, fuel pump, kiosk terminal, POS terminal, etc. |
| Receipt ID | This may be used by a merchant, separate from a transaction ID. The |
| | receipt ID may be unique within a location and/or per day and/or per |
| | machine and the transaction ID may be unique across the merchant |
| | parent entity. |
| Customer Information | Basic customer information like name and address may be obtained |
| | and stored. This customer information is separate from the |
| | information stored about the account owner. This is the information |
| | that the customer may have given to the merchant. |
| Employee Information | The name of the merchant employee that processed the transaction |
| | may be recorded. This may be different to the salesperson or |
| | restaurant waiter, which may also be recorded. |
| Shipping Information | Shipping information may include the shipper, a description of the |
| | service, cost of the service, the carrier service level, and a tracking |
| | number assigned by the merchant or carrier. |

It will be appreciated that in the noted exemplary table entries, a particular data element may be comprised of composite data, where the elements may have sub-fields associated with them. Sub-fields provide additional details for a given field and they may be separately searched and parsed. For example in “Shipping information,” the “shipper” data may have sub-fields providing descriptions relating to the name, address and other contact information.

When the item is purchased, a receipt record and item record is created for the item providing details regarding the purchase of the item, as noted in Table A. Authorized users of the system can then examine the data relating to the purchase. Data analysis may incorporate the details of the purchase in reports, such as aggregate sales reports.

After the purchase of the item, a follow-up transaction may be effected, such as a return, a repair, an amendment, a transfer, a gift, a rebate, a reimbursement submission, etc. In processing the follow-up transaction, a separate data object is created and maintained, which may be searched by an original receipt identifier and a tracking number for the follow-up transaction.

Revisions to records may be made by supplementing an existing record with current information or by modifying an existing record. Links among data structures of an embodiment are illustrated in an example where a record of an item is updated to reflect the return of the item to the merchant. In this case, return information is added to the returns table and to the returned items table. The records in these tables, respectively, have references to the corresponding records in the receipt table and the receipt item table.

Exemplary features of data structures for followup transactions are provided in the context of processing an item for return, shown in the association chart for accounts, gifts and reimbursements shown in FIG. 10E and table group 302. For a return, a separate return record and return items records are created and maintained in a return table and return items table. In updating the records for the return, the receipt record may be amended to add the information about the return to its record instead of modifying its existing data. When the return is affected, the return record may be created to include one or more of the following information: the identification card used to authenticate the user at return time, the return time, amount of money returned, and other return details. In a new item record, line item return information may include: quantity returned for the line item and return price. State fields for the original item record may indicate various states for the item, such as whether or not the item has been returned, gifted, submitted, or authorized for return.

Other post-purchase data processing facilities are provided. Receipts and individual line items may be bundled together to form a logical group (e.g. through a folder). The grouping information may be stored in a separate table as depicted in the association chart of FIG. 10E. A defined group may include notes about the group and time data regarding its creation and amendments. Items in a group may be stored using an association table relating the group record and either a specific line item or whole receipt records. A group can be used to logically package data to be submitted to other accounts for reimbursement or proof of purchase requirements when dealing with insurance or accountant type agencies. A group can also be used to send gift receipts to other accounts, allowing the receiver of the gift to have access to the receipt for the item to enable the receiver to access the record to process a return of the gift, if necessary.

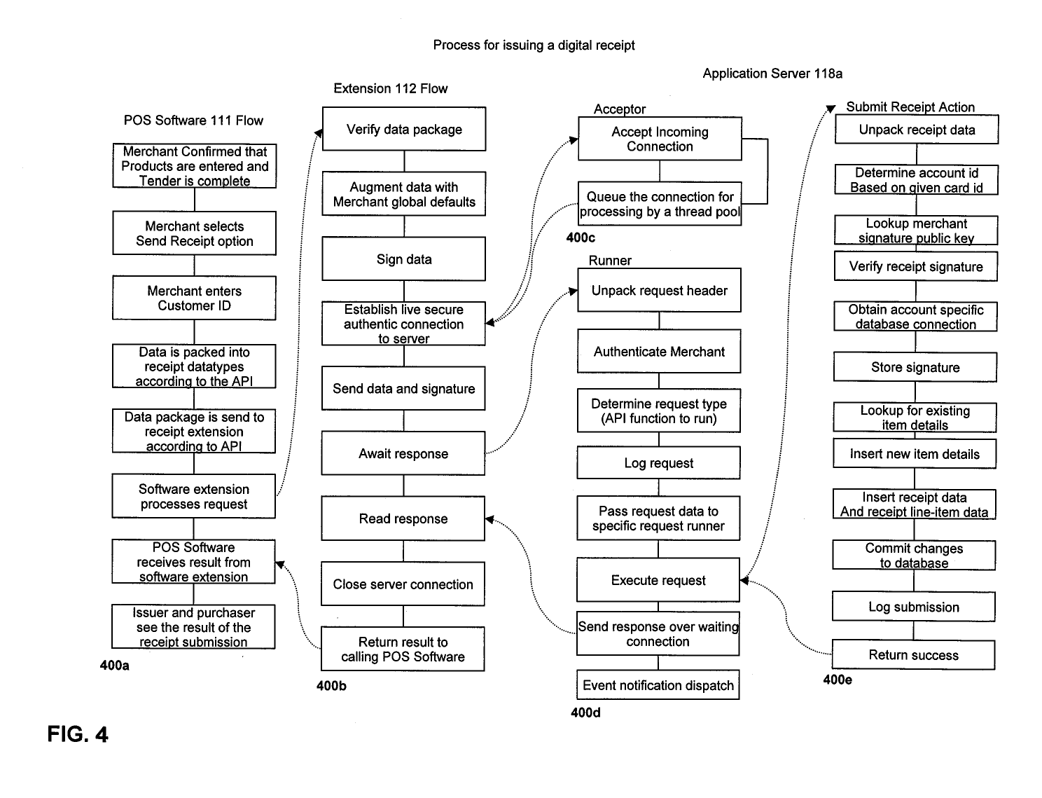

Now, further detail is provided on processing records for a transaction by an embodiment. FIG. 4 shows a series of connected flow charts for processes operating on the merchant's POS and the central server in creating and storing a transaction record for an exemplary purchase of an item by a customer at a merchant.

Flow chart 400a shows exemplary processes in issuing and storing a transaction record according to an embodiment. After merchant POS software 111 processes the transaction in the traditional manner, when the digital receipt option is selected, in lieu of or in addition to a paper receipt, the user's identification code is accessed (e.g. through manual insertion or reading the data from card 102). Next, fields such as the user's identification code, the SKU of the item, the date, the quantity, the price, the taxes, tender, and other data are packed into a form suitable to be passed to application extension 112. Once the transaction record is sent to application 112, the terminal software awaits a response from application 112. When the response is received, the purchaser and issuer are notified of the result. A digital receipt is now stored in the system 110. In this embodiment, POS software 111 can be considered to be an external process to the embodiment, such that the POS software obtains all data for the receipt and makes all calculations for the transactions. The processed data for the transaction is then provided to server 110. In other embodiments, one or more calculations, reconciliations and post transaction processes, etc. may be provided either by POS software 111 and/or by server 110.

Flow chart 400b shows exemplary processes by an application extension 112 in processing a terminal 106 request to issue a receipt to be stored in server 110. The receipt information may be provided to the extension 112, by the POS software on terminal 106, as a well-defined class object or a string representation such as YAML or XML. A verification step may be provided to detect formatting and other errors and/or data omissions in the record. Next, the record may be supplemented with any additional merchant-specific data. For example, the POS software does not need to handle the merchant identifier because the software extension can handle that piece of information required at the server. The data is then signed by module 112b and the resulting certificate is added to the receipt information.

Next, a secure connection to server 110 may be established. Flow chart 400c shows exemplary processes at server 110 that process the connection request. First, the incoming connection, which can be a secure socket layer (SSL) connection, is accepted and then the connection is queued for handling by a thread pool. Once the connection is established, the process shown in chart 400b continues and sends the data including the signature over the connection to server 110 and then it awaits a response from server 110. Alternatively, persistent connections can be used so that there is less network overhead for establishing individual SSL connections for one-time use. In that scenario, the server would wait for new requests coming in from that existing channel and queue the individual requests for processing by the pool.

Next, flow chart 400d shows exemplary processes executed at server 110 in initially processing the merchant's request to store a new receipt. First, the data is received and the header of the data is unpacked. The header may contain protocol version, client version information, message length information, message encryption information, merchant authentication information, and application program interface (API) function information. The merchant can be authenticated using a simple passkey method where the merchant sends the secret passkey and the server compares it to the expected passkey for that merchant. The server can find this information in the database. The system determines the request type that can be one of the defined API functions, such as ‘submit new receipt’, ‘submit return receipt’, ‘lookup customers’ receipts’, ‘fetch detailed receipt information’, ‘void transaction’, and ‘fetch coupons’, etc. Details of the request may be logged, such as IP address of requester, merchant ID, API function, and function parameters, etc. Details may be recorded to allow tracking and analysis of system usage. Analysis can reveal security breaches, flaws in merchant or server software, breaches of license agreements, and areas for optimization or other improvement. The process in FIG. 4 continues by handing the request to a specialized request handler.

Next, flow chart 400e shows an exemplary process executed at server 110 for creating a new transaction record during a new-receipt request function execution. First, the transaction data is unpacked from the serialized form into object form. The appropriate account is determined based on the card given by the purchaser to the merchant, which is part of the receipt data. The system searches the database for the public key specified by the transaction data. The public key can be used to verify the merchant's signature for the transaction data. If the signature is verified, processing continues. Signatures are stored for reasons as previously described (system security and system trust). If the signature is not verified then the merchant software receives error notification through an error response. The lack of verification may represent an attack, failure of the merchant to update the signature key information or some other synchronization issue. To increase database scalability, multiple database servers may be provided where each server assumes responsibility for a different section of the entire database. In FIG. 2, for database 116, exemplary records identified as 0-z are stored. Databases 116B, 116C and 116D are provided to collectively store and manage those records. Database 116B tracks records 0-x; database 116C tracks records x-y; and database 116D tracks records y-z. Database manager 116A assists in identifying which database 116B-D to access when a particular record is being requested. The identification process may be determined from an analysis of the related account. Alternatively, an application server may have facilities to identify an appropriate database 116B-D and communicate directly with it to process a given record.

A merchant may sell thousands of a particular item in many transactions with different purchasers. To reduce storage requirements, the item details are stored once and are simply referred to by each relevant transaction. Server 110 will search database 116 for an existing item detail record with common determining characteristics, such as description, Universal Product Code (UPC), regular price, sale price, etc. If no match is found, a new item detail record will be inserted. This enables an embodiment to reduce data synchronization requirements among different merchant inventory systems with database 116. Items can be distinguished by UPC or other similar code, or if unavailable, the description. Line item records with the same UPC code may have different prices and they must be treated as separate items to preserve the price information. Line-item details may be stored with the receipt item record, allowing information, such as related serial numbers, to be recorded for a line item while still allowing common information, such as tax rate information, to be stored in the common item details record.

The transaction information including receipt information, such as date-time, system account, card used, merchant, total amount paid, subtotals, taxes, tender details (credit card digits, authorization code, change given, amount tendered), and item information like quantity, serial number, line total, item reference, and including the signature, are committed to the database. Next, the receipt submission is logged to keep a second record of the details of the submission separate from the database. The log data may include connection details and the data represented in a raw data format. This log data may be kept and accessed as a backup in the event that the database becomes corrupt. In a situation where the database is not available (e.g. due to malfunction or connection issues or load issues), the request can be queued for database submission and may be executed at a later time. The queue may exist as a log file kept for each master. When the database is reactivated, the queue can be processed and the data will be inserted into the database.

At this point, the execution returns to flow chart 400d, where the success flag is received and a response message is generated and sent over the channel 114 to the terminal interface process 112.

Upon completion of the request, other processes may occur that have been hooked onto the event. An example of this feature is having an email or text message sent to various registered parties informing them of the event and its details.

Execution returns to flow chart 400b, where the response is received by software extension 112 and the server connection is closed. A message to the POS software 111 is then generated and sent.

Finally, execution returns to flow chart 400a, where the response is received and the POS terminal 106 displays the results of the transaction submission. A hardcopy of the same may be printed. A record may be sent as a message to the user's PED. With the report, the transaction of adding the record is complete.

It will be appreciated that database servers 116 may partition the stored data (e.g. databases 116B-D, FIG. 2) by storing information relating to certain accounts only on certain servers or storage devices. This may reduce the data capacity requirement of individual servers or storage devices. In addition, servers 116 may be replicated so that the data of the overall system is stored in multiple locations, providing data backup and server load balancing. The system may define multiple database master servers and use them accordingly. For example, a set of database servers can be set up where each server handles the write requests for a mutually exclusive subset of account numbers. A table may be maintained identifying access information for the servers and the data that each manages. When a write from the website or application server is being provided (for inserting new transaction details, adding return transaction details, and changing receipt-item state information in supporting gifting and submitting) the web server or application server may be able to identify the location of the appropriate master server through a query to the lookup table to identify a URL of the appropriate master server. Then the application may obtain a connection to that server and then perform the database transaction. The tables listing database URLs may be updated at runtime without server restarts allowing seamless changes like additions of new partitions or the splitting of a partition and changes for fail-over. These lists may be cached at each server. The lists may comprise account identification (ID) ranges mapping to database servers. A database server may appear at multiple differing ID ranges. Other ID partitioning schemes may be used such as using simple modulo operations on the account ID corresponding to the number of partitions used. There may be masters handling other aspects of the database structure, for example, organization and user profiles, and access permissions and roles. There may be slave servers that copy the data from the master servers. These slaves may copy data from multiple masters or from a single master. One role for a slave may be to serve the data when read-only access is required. The same lookup table used to identify a master may also be used to select an appropriate slave for read only connections. In the event of a master failure, a slave may become the new master. Alternatively or in addition, the data may be partitioned within each master by separating data in the same way and storing the data on separate storage devices in order to reduce input/output performance issues, reduce bottlenecks and increase parallelism. Examples of storage devices include a single disk, an array of disks in a machine, a separate network storage appliance, and virtual storage devices like what virtual servers can use. Other known database scaling techniques may be used such as database clustering. It will be seen that with account IDs as a sorting field, this facilitates logical partitioning of the data.

With a description of exemplary processes used to generate a transaction record provided, an embodiment can then use data in the transaction record to process additional transactions that provide more flexibility than transactions requiring a production and presentation of a paper receipt. For example, an embodiment provides flexible and paperless transactions relating to returns, coupon processing, gifting of a product, and account expense tracking. Each feature is discussed in turn.

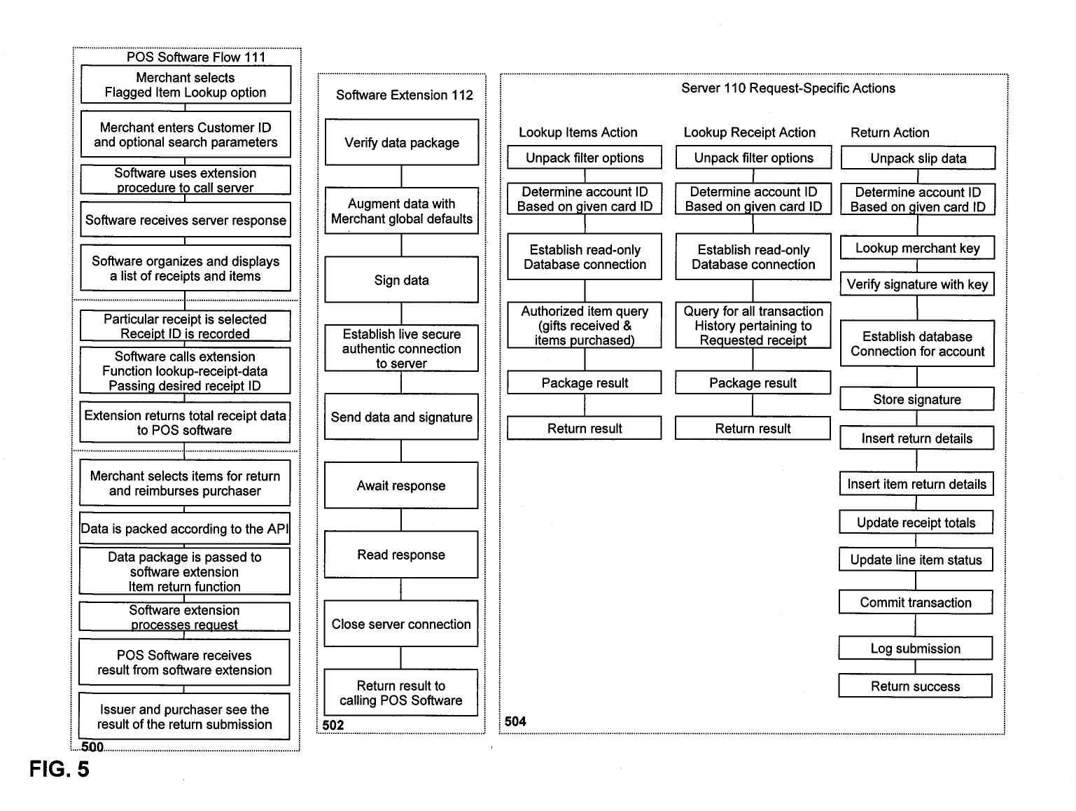

FIG. 5 relates to a return transaction, showing a series of connected flow charts for processes operating on the user's terminal, the merchant's POS and server 110 in processing an exemplary return transaction for a product. A return may be initiated after a purchase is made, per FIG. 4. Merchant POS 106 executes a series of processes per block 500 to first identify a transaction record relating to a product to be returned, then retrieves a full transaction history for that item, then builds and sends a request to process a return to software extension 112 for delivery to server 110, and finally receive any results from the request.

Generally, before initiating a return, a target receipt record will be identified by the user. To do so, the user authorizes (“flags”) selected items or the entire transaction receipt for return to the merchant using an available interface, which may be a GUI or a text-based interface. For example, the user logs into the website, locates the applicable receipt in their list of receipts, accesses that receipt and flags items on the receipt. “Flagging” a record modifies the information in database 116 as to that particular record, allowing the corresponding merchant to filter user transaction records in the system for that merchant for flagged records. The specific record for the return can then be identified, accessed and updated to complete the return transaction. Alternatively, if the user does not “flag” an item or receipt for return, the merchant can enter the user's account identification into the POS terminal and manually search receipts issued to the user by that merchant. A user may selectively disable the search function via a command on the website user interface and allow the merchant to access only records from a list of authorized records. Completing the return transaction adds item return information to database 116. This updated status is reflected when the user or merchant accesses the transaction record thereafter.

When updating a record for an item being returned, initially, at the POS terminal, the user's ID or the transaction record number is entered and the “return item” option is selected. Requesting a filtered list of flagged receipt summaries from the server may help identify the appropriate transaction record. Alternatively, a search for transactions pertaining to the identification code for the user and product code for the item to be returned can be performed. Other search and filter parameters may be specified such as a date range and merchant location. Once a transaction has been identified a full transaction history is retrieved in a receipt lookup action. The user and merchant can now see details of the transaction to make sure it is the relevant transaction. Also, the merchant can see the states of the items on the receipt and their availability for return. The item may have been involved in a rebate or other transaction, which revokes return rights for the item. If the item return is acceptable, the merchant records the transaction in the POS system and returns the funds. Details about this transaction are sent to the server to be stored.

Software extension 112 executes a series of processes per block 502 to first receive the various requests to process a return from POS 106, package and send a request to server 110, and subsequently receive any results from server 110, and forward same to POS 106. Block 504 provides an illustrative set of processes executed by the software extension, when sending a request from the merchant POS to server 118. This block provides three specified functions: lookup flagged items; lookup data for a particular receipt; and send information about an item return transaction. Other functions may be provided. Once a particular receipt is selected, a request for updated information for the record is sent via the extension from POS 106 to server 110 so that the POS software can display the total receipt data. After a return transaction is executed at POS terminal 106, the merchant selects the item(s) being returned on the record being displayed. Once the return is complete, the updated record needs to be provided to server 110. As such, POS terminal 106 creates an adjusted record data package and sends it to the software extension. Again, the extension verifies the data package, signs the data, and sends a request to the server to process the data package and submit the revised (i.e. return transaction) receipt.

Server 110 executes a series of processes per block 504 to first receive the request to process a return from extension 112, process a request relating to the return and package and send a response to extension 112. The processes in block 504 are executed in place of 400e where the server still executes 400c and 400d for each request. Three exemplary return-related functions are provided by server 110: look-up flagged items for a possible return transaction; look up receipt data; and processing a return of an item and updating the receipt information in the database. The lookup items function may return a list showing details of each transaction returned. It may not be necessary to find all information about every receipt. Doing so may be costly in terms of processing power and data transfer. Once the desired transaction is identified including the transaction ID, its data can be requested in full by a separate request.

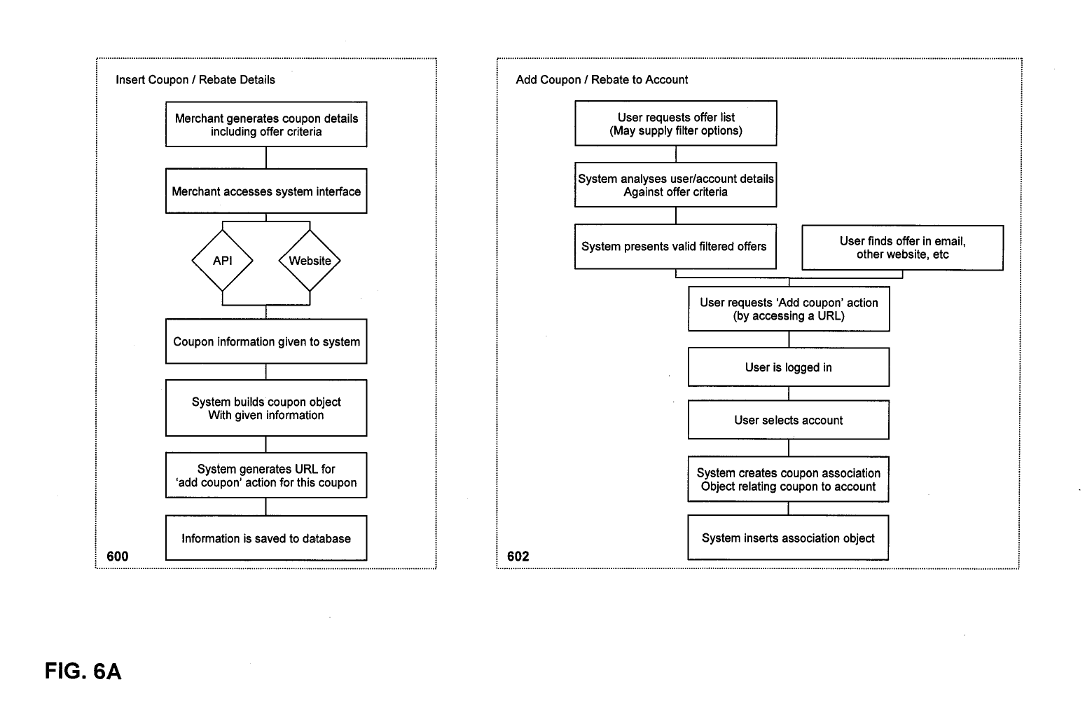

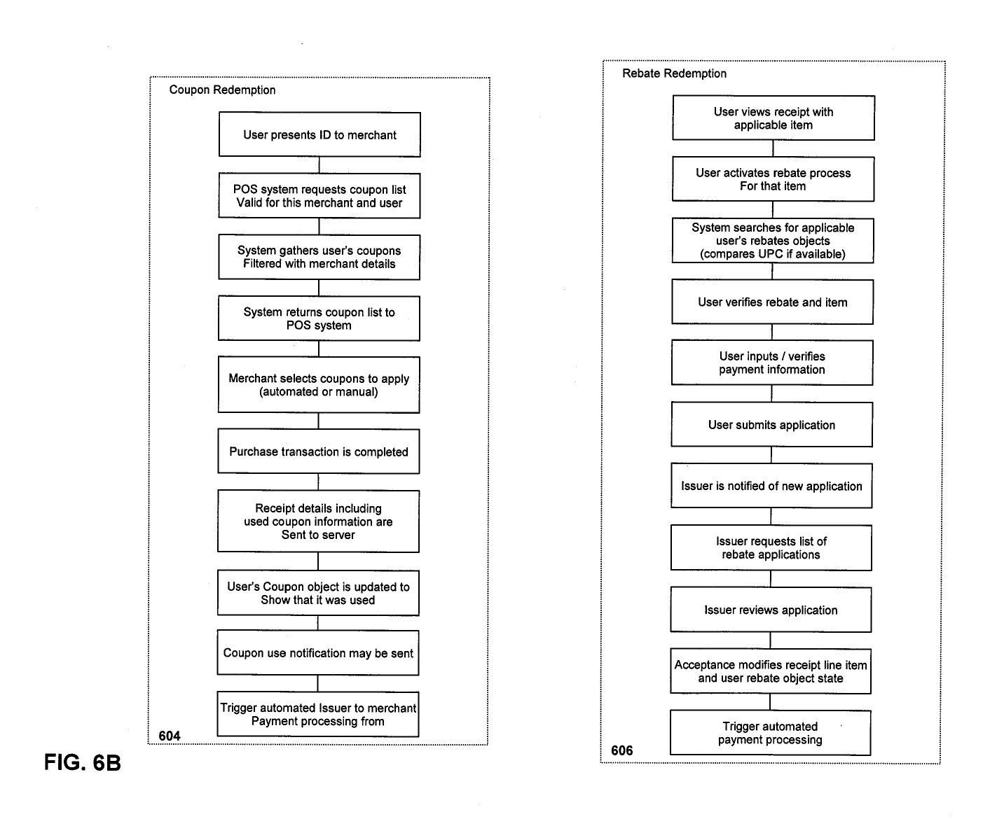

Further detail is now provided on coupon/rebate access, retention and redemption features provided by an embodiment. FIGS. 6A-6B show a set of flow charts for actions that a user initiates (either through a GUI on website 120 and/or at a merchant's POS) in using the coupon or rebate system. As noted earlier, merchant POS software 111 may conduct one or more processes in identifying and associating a coupon with a transaction. In such an embodiment, POS software 111 provides transaction data to server 110, which includes data where a coupon has been applied. Server 110 at this instance expects that the transaction data it receives does not require further processing. In other embodiments, one or more processes, such as application of coupons, and return of coupons, etc., are implemented by server 110.

In FIGS. 6A and 6B, block 602 illustrates a set of actions that the user takes to claim merchant coupons that may be redeemed by the merchant at the POS terminal 106. Digital coupons and rebates may be made available via the website GUI to participating users. Digital coupons have logical features that follow traditional coupons (e.g. rebate value, quantity limits, expiry dates, and other restrictions and features). An embodiment allows a database of coupons to be accessed to identify a set of digital coupons/rebates that are to be associated and stored with an entity, e.g. a user, a transaction record, a merchant, a merchandizer, etc. An embodiment also controls how and when coupons are accessed and presented to a user. For example, a GUI may provide a viewing window where identified digital coupons may be presented to a user at certain instances of a transaction. For example, a coupon record may be displayed after a product is selected or a “check out” action is initiated to finalize a purchase. Further details on notable features of a coupon management system are provided below.

As noted, an embodiment provides access to a set of coupons by a user. Coupons may be globally accessible through the system (e.g. from manufacturers) or access may be restricted on certain conditions (e.g. specific-store coupons, regional coupons). The system provides a GUI to access available coupons for a user. When the user visits the coupon webpage (which may be supported by the merchant), the embodiment analyzes the data for the user (e.g. address, age, available demographic information, recent buying patterns, etc.). For example, a merchant may add a coupon to the system and have it offered only to users who are students, who visit frequently, and who have previously purchased certain items. A determination is made to identify appropriate coupons that should be presented to the user in the GUI. The determination can be based on access/restriction conditions as noted above (e.g. specific-store coupons, etc.). In one embodiment, coupons are processed at the merchant POS and post-coupon transaction data is provided to server 110. In other embodiments, one or more processes relating to coupon processing (as described below) is performed by server 110.

In FIG. 6A, block 600 shows exemplary processes implemented to create a coupon for the embodiment and build and store its details in to the database. Block 602 shows exemplary processes implemented to add and apply a coupon or rebate against an account for the embodiment.

As shown in FIG. 6A, server 110 may also provide an interface (either web-based or through a POS) so that merchant servers 108 or other outside systems can connect to the system to input coupon or rebate details.

In the coupon GUI, a list of available coupons for the user may be presented. The user may “clip” (using an analogy to traditional paper coupons) a set of coupons that he wishes to use (either now or later). The action “clipping a coupon” may be initiated by clicking a web link to activate a URL that encodes a coupon identifier. The link may be generated or advertised on an independent website and refer to a coupon within the system. The link may direct the user to a web application where the web application can associate the user session's selected account with the identified coupon. “Clipped” coupons can be viewed at anytime by the user via the website user interface. When the user “clips” a coupon, a clipped-coupon record is created in the system, which provides a link between the account and the coupon. The record may also store additional data, such as user notes, date clipped, a state field indicating if the coupon has been used, and any other details or restrictions associated with the coupon. Coupon records may also include a reference to the merchant, the coupon particular, any special conditions or expiry dates, item description, a link to a promotion page, and it may have a reference to common item details records used by receipt item records.

To redeem a particular coupon during a purchase, a user presents his account identification code to the merchant POS. In an embodiment, the POS system 106 may make a request to the server 110 to retrieve a list of clipped coupons. At the POS a store clerk can view coupons that are compatible with products or services that the user would like to purchase and apply desired coupons at the user's request. Once a coupon is selected, the system can also check any restrictions of the coupon as stored in its coupon record, against the transaction. If there is a discrepancy, a flag may be raised indicating that the coupon cannot be applied. If no issues are identified, then the value of the coupon may be automatically processed against the transaction. Alternatively the system allows the clerk at the POS to override any discrepancies with the coupon and to apply it against the transaction. Once a coupon is applied against the transaction by the POS system 106, the value of the coupon will be appropriately reflected. The POS system packages the coupon information with the transaction data package so that the server 110 can update the clipped coupon record in addition to storing the receipt data. The system will update the clipped-coupon record to indicate that it has been redeemed, and may include a reference to the corresponding transaction record.

The coupon system may also handle coupons issued by entities other than the merchant where the product is to be purchased. A coupon record may include a field or list determining store relevancy. A manufacturer or other entity can create a coupon record with restrictions, such as when acceptance of the coupon is limited to a particular set of merchants. When a request is sent to the system for coupons (e.g. either at an initial request from a user or a request for clipped coupons for user), the server will identify and return the relevant coupon records. The coupons may include coupons that are valid at selected merchants. This can be accomplished by filtering the coupon list to identify coupons that are created by a particular merchant or that include the merchant on an accept/deny list. Further filtering features may be based on merchant industry, regional filters or other parameters.

The database tracks a total of the number of coupons used and provides a notification to the coupon issuer and the merchant of the balance owed for honoring the coupon. Tallying coupon redemptions may be done periodically or when the server detects that coupon redemption is being conducted for a user's account. Redemptions tallies may be made on a store-basis, a regional-basis or a time basis, etc. (or any combination of these tallies).

Further detail is now provided on processing rebate functions. Rebates are similar to coupons in some general aspects, but there are differences. For example, rebates may be offered by entities that are not necessarily closely tied to the product. Frequently a coupon is offered by the manufacturer of the product associated with the coupon. Also rebates may be processed during or after the transaction is completed. In some instances, a purchaser is required to send in a proof of purchase to a processing center and then the processing center reviews the documents and provides the funds associated with the rebate, upon approval. A rebate can differ from a coupon in that a separate additional, external request may be required to be performed in order for the rebate to be applied after the transaction itself has been completed.

An embodiment provides for tracking and processing a rebate where users can access rebate offers via the website interface, which will be made available through a rebate search engine and advertising.

In FIG. 6B, block 606 illustrates a set of user actions performed using an embodiment to redeem product rebates from manufacturers or other organizations. After a record for a purchase transaction has been entered into the system, the user may access the records to attempt to identify and apply applicable rebates. The effect of applying a rebate is that the appropriate monetary compensation is transferred back to the user electronically (e.g. PayPal, trademark, direct deposit online banking) or through conventional means. Submission of the rebate request replaces transmission of a separate rebate form to the appropriate merchant/manufacturer. Once a rebate is applied, the record for the transaction is updated to reflect the rebate. The record may be updated to indicate that returns are restricted (to a time limit or dollar amount) or not allowed after the rebate is applied.

Rebate records may be created, linked and administered by an organization in a similar fashion to maintenance of coupon records. A record will have several fields, such as: rebate issuer, issue date, expiry, rebate value, rebate terms, item description, UPC, and an external promotion link such as to a manufacturer website. A database is used to store created rebate records. Purchasers may visit the website 122 and view a list of rebate offers. Rebate offers may be provided with coupon offers or may be provided under a separate GUI. Rebate listings can be sorted and filtered by date, value, item category, item description, manufacturer, and other data parameters available to the system. When a user has identified a rebate that he would like to track, the rebate record may be “clipped” by the user, which has the effect of creating a new clipped-rebate record linking the rebate record to the user's account in the system. The user can view and manage a list of clipped rebate offers.

After the user purchases an item and the purchase information is stored in the system, the user may then use the system to locate the transaction receipt and then initiate a rebate submission process. The user selects the item for rebate and matches that item to a clipped rebate. A user may be presented with a list of possible rebates to apply to the item. This list may be filtered by information present in the item details such as UPC. A new object may be created in the database storing information that relates a rebate to a receipt line item along with submission details such as how the funds are to be transferred, date of submission, and others. That object may be the same object that is created when a user bookmarks a rebate offer (see FIG. 10G showing tagged/used rebates). In that case, more information augments the existing object. Receipt item details are updated to reflect the rebate state. A message may be sent to the issuer informing of the new submission. The rebate issuer has access to a list of completed or pending submissions. The issuer can transfer funds and mark the rebate submission as being accepted. The user has access to a list of redeemed rebates.

As an alternative system, a rebate search engine is provided at server 110 to scan records of a given user to identify existing purchases and cross reference such purchases against potential applicable rebates tracked by the system. Use of universal tracking codes, such as UPCs provided by the manufacturer, and association of such codes with transaction records assists with identifying products and associated rebates. The system may then display a list of matched rebates to the user through the GUI.

When the user selects a rebate, a rebate submission process is initiated. As part of the process, the user specifies payment details. Additionally, the user and the rebate issuer may specify preferred payment information as user profile information. The submission process may use this information as default information when the user is asked to specify it during the process. Additionally, when the submission has been accepted, the system may facilitate automatic, or initiate, fund transfers from the rebate issuers preferred account, to the purchasers preferred account.

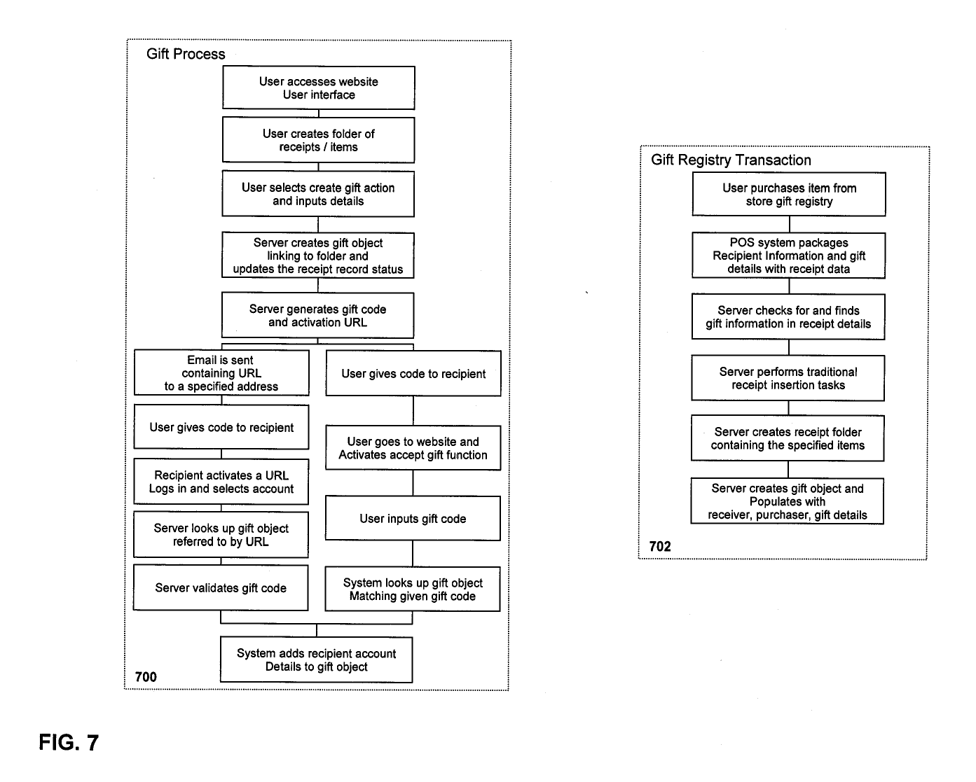

Now, further detail is provided on a gift process for an embodiment. A gift process allows a user to designate an item relating to a transaction as a gift and to send a redacted transaction record relating to the gift to another user. A gift can be a bundle of gifts from one user to another or a group gift from several users to another user. FIG. 7 shows flow chart 700 for processes operating on the user's terminal and server 110 in processing an exemplary gift transfer request relating to a transaction record. The recipient of the item can return to the merchant and use the redacted transaction record to process a subsequent return or exchange of the item. All this occurs without the need of the recipient of having an original paper transaction receipt. FIG. 7 also shows flow chart 702 for processing a gift registry transaction.

Once a user has completed a purchase transaction, he may access the system to view his transactions and identify a specific transaction item, whole transaction or groups of those as a “gift” and specify the recipient. The system updates the state of the transaction to be “gift”, once an acceptance of the gift is provided. A redacted record may hide one or more fields from the original record, such as the price or the ID of the originating user, etc. The recipient will be able to view a list of these transaction records of gifts received. If the recipient wishes to return or exchange the item, he can subsequently “flag” the item for return on the website, following previously described return functions. The user may bring the item back to the merchant and provide their account ID. The request may be processed in a similar manner as that described for FIG. 5 in block 504 for a return transaction. The “lookup items” function would return data relating to items purchased on an account as well as gifts received. Filtering may further restrict item searches to retrieve only “gifted” and “flagged” items from database 116, so that the record may be found more easily. A user is provided with a GUI to view a list of receipts filtered for items that he has gifted to other users. The amount paid by the gift donor remains listed even if the item is returned so that it may be included in personal accounting operations by the gift donor. The return details are otherwise recorded and available to the gift recipient. Details about a gifting action may be stored in the system where detail fields may be stored and recalled by parties involved. Examples of fields that are part of the gifting object are: date gifted, donor name, receiver name, receiver account, donor account, date received, reference to the transaction information, user supplied notes, tax receipt details, and a personalized message to the receiver.

A gift recipient may be marked through several different processes. When a user completes a purchase intended to be a gift, the transaction record can be tagged to indicate that it is a gift. The purchaser may identify the purchase as being a gift through a GUI or through the merchant's POS. When tagged as a gift, the transaction record may be updated to receive details about the recipient of the gift, including any account identifier for the recipient. A gift record may also be created, tracking details of the gift (e.g. description, purchaser, recipient, warranty information, restrictions on return, etc.). In one embodiment, the recipient's account identifier is not automatically provided to the purchaser. In such an instance, the recipient is required to provide his account identifier to the user via an external means, e.g. verbally or through email. Upon entry and submission, the gift record would be complete. Alternatively, in lieu of providing the recipient's account identifier, upon identification of the transaction as being a gift, the system can create and process a new gift identification code, which is stored with the gift record. The gift identification code should be sufficiently complex to prevent unauthorized attempts from third parties from guessing valid gift identification codes (e.g. a random number concatenated with hashed gift object identifier). The gift identification code is provided to the purchaser and the purchaser is responsible for transmitting the gift identification code to the recipient (e.g. via email). The recipient would access the system and enter the gift identification code to accept the gift. Alternatively, still the purchaser may select an item for gifting and provide an email address for the recipient. The system can then generate the gift identification code and generate and send an email to the recipient, with any associated message. The email may include a URL that the recipient can activate that would take the recipient to a website for the system to initiate a gift acceptance process.

When a recipient of a gift accesses the system and provides the gift identification code to it, the system will search for a gift record that matches the provided gift identification code. If a match is located, the gift record is updated to populate any relevant data fields (e.g. recipient field, the account selected by the user who used the gift code, etc.). An email may be sent to the purchaser and the recipient notifying of a successful gift transfer.

The system also provides links to external gift registry services. After a user establishes an external gift registry account with a merchant (e.g. for a wedding registry), information about a transaction can be provided to the registry for further processing and updating of its registry records. Details of the user's account may be provided to the merchant when the user creates their gift registry. When the purchaser purchases an item from a merchant, the merchant may ask whether it applies to a gift registry. If the purchaser confirms this relationship, the merchant may flag the transaction as being a gift and access the system to link the purchase to the related account tracked by the gift registry. Once details of the gift registry account are identified, transaction details may be sent to the server to update the purchaser's account and gift registry account. The transaction details may include the recipient information. The recipient information may be stored as extra item details or as extra receipt details or both. The server may verify the gift transaction (e.g. checking for the existence of a gift registry account and whether the gifted item is in the gift registry account). If details of the gift transaction match, then a gift record is created and added to the system. The gift record links the purchaser with the recipient and the gifted item. The gift record may include: the recipient account information, item(s) included, and other details. For proper gifting protocol, specific fields in the gift record may be requested to be hidden from the recipient by the purchaser. Such limits may be lifted after a certain date or when there is a request to make the details visible. Multiple gifts and recipients may be included on a single transaction. An embodiment also provides visibility and access controls for gift records. For example, a gift record may be marked as “hidden” from its recipient until a specified ‘delivery’ date, while still maintaining a logical link to the recipient. This “hide” feature allows a link to be created while preserving a surprise of the gift to the recipient. When an “unhide” event occurs, the gift record is updated to be “revealed,” thereby allowing the recipient to review the gift receipt. These gift presentation features apply to any gift record that is tracked by an embodiment.

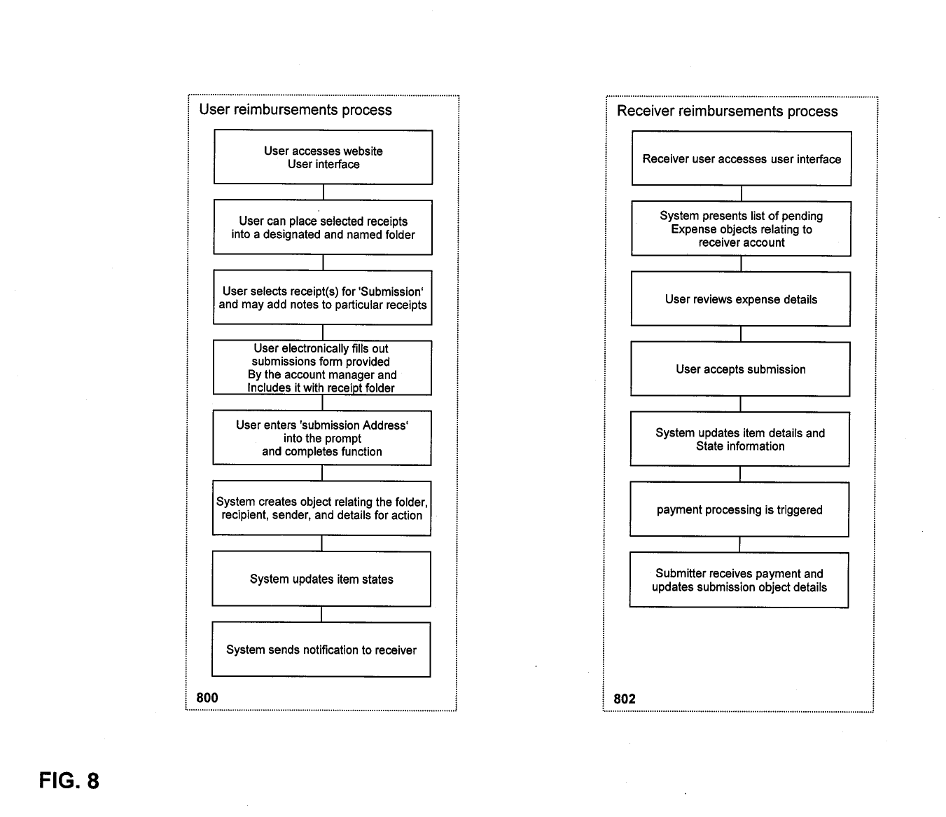

The system also provides expense account processing services. FIG. 8 shows flow chart 800 for commands on a user's terminal for initiating an expense claim process for a transaction record. The expense claim process allows a user to designate an item relating to a transaction as an expense item and to send a transaction record relating to the item to another account, presumably of an expense department that will ultimately process and approve/reject the request. The expense claim process can operate without having an original paper transaction receipt for the claim. FIG. 8 also shows flow chart 802 illustrating exemplary processes for processing a reimbursement request at the receiver's side.

Once a user has completed a purchase transaction, he may access the system to view his transaction records and identify one or more records for submission as expense claims. When the record is flagged, the system updates one or more fields in the record. The state field may be updated to show it to be submitted for an expense claim. A submission data object may be created in the system to store information about an expense submission. The fields may include: originating account, destination account, date submitted, user notes, date accepted, user name of the acceptor, submission state, and other information.

The submission state information can be used to track the expense claim through its processing. Processing an expense claim can go through several stages, which may or may not be linearly connected to other stages. The stages include: a draft stage, where the user can add items or records to the expense bundle; a submitted stage, where the submission has been completed and transmitted to the expense department through the system; a review stage, where the expense department has confirmed receipt of the expense claim and is processing same; an accepted stage, where the expense claim has been approved and so a reimbursement process has been initiated; a further request stage, where the expense claim requires further detail; a refused stage, where the expense claim is rejected; and a completion stage, where the user has been reimbursed for the expense claim.

Processing an expense claim may involve retrieving and updating data relating from several data objects managed by an embodiment. Data objects relating to a rebate process may include: messages between the parties involved, references to the items involved and data belonging to a submission form which is customizable by the receiving account holders. A web page is available to the user to allow him to inspect and review items that were submitted. Similarly, the expense department can review the user's items that are received. The accounts that may receive reimbursement requests may have access to a web page which allows the user to define fields that must be filled in by the requesting users and which are attached to the reimbursement request. Like the rebate function, the system may facilitate automation of funds transfers through the pre-designated preferred accounts. The information about how the funds were transferred and any tracking information may be stored with the expense submission data object.

In processing an expense claim, an embodiment allows a third party to be provided with selective access to records in the system to review receipts relating to the claim. An embodiment provides for specific third parties to obtain selective access to data in the system. For example, a user may submit receipts to his accountant (the third party). The system can be structured to provide the accountant with selective access to the user's data. The accountant may then access the related folder in the system and view the receipts to verify accounting data as needed. The accountant may acknowledge the inclusion of an item for expensing purposes, but the funds transfer stage is skipped.

Another feature allows forwarding of an expense claim record. For a forwarding process, a set of receipts are added to a folder, accompanying text notes for the folder are provided, the recipient(s) of the folder are identified (e.g. an auditor, accountant, lawyer etc.), and the folder is “delivered” to the recipients. The recipient may then be provided with access to view the data as a received folder. The level of detail that the third party is provided access to is configurable, but it may be similar to the level of data provided to merchants in a gifting transaction. To control access to the data by third parties, account identifiers may be explicitly designated or an email containing instructions and an activation URL may be sent to a specified address.

Continuity checks for expense claims may be provided. If the user attempts to return an item that was previously submitted for an expense claim, the merchant would see in the receipt details that the item was submitted for reimbursement. The merchant may take this as a sign that the purchaser no longer has the “proof of purchase” necessary to honor the merchant return policy. The receipt can still be used as proof for warranty purposes. Further, the expense department may be provided with the authorization to override return refusals. As such, the expense department may be able to flag an item in question as being returnable. This status can be used by the merchant to signify that acceptance of the return is at the discretion of the merchant.

For each of the above noted transaction functions (purchases, coupon/rebate applications, warranty information, gift processes, and returns), an embodiment can generate a report that presents summaries of transactions based on user accounts, merchants or type of function. Time and location parameters may be provided for any report. As such, reports can be generated for all returns provided to a particular merchant in the province of Ontario during the month of May. A report may be based on a particular user's account for the analysis of the user.

Further detail is now provided on additional account management processes provided by an embodiment.

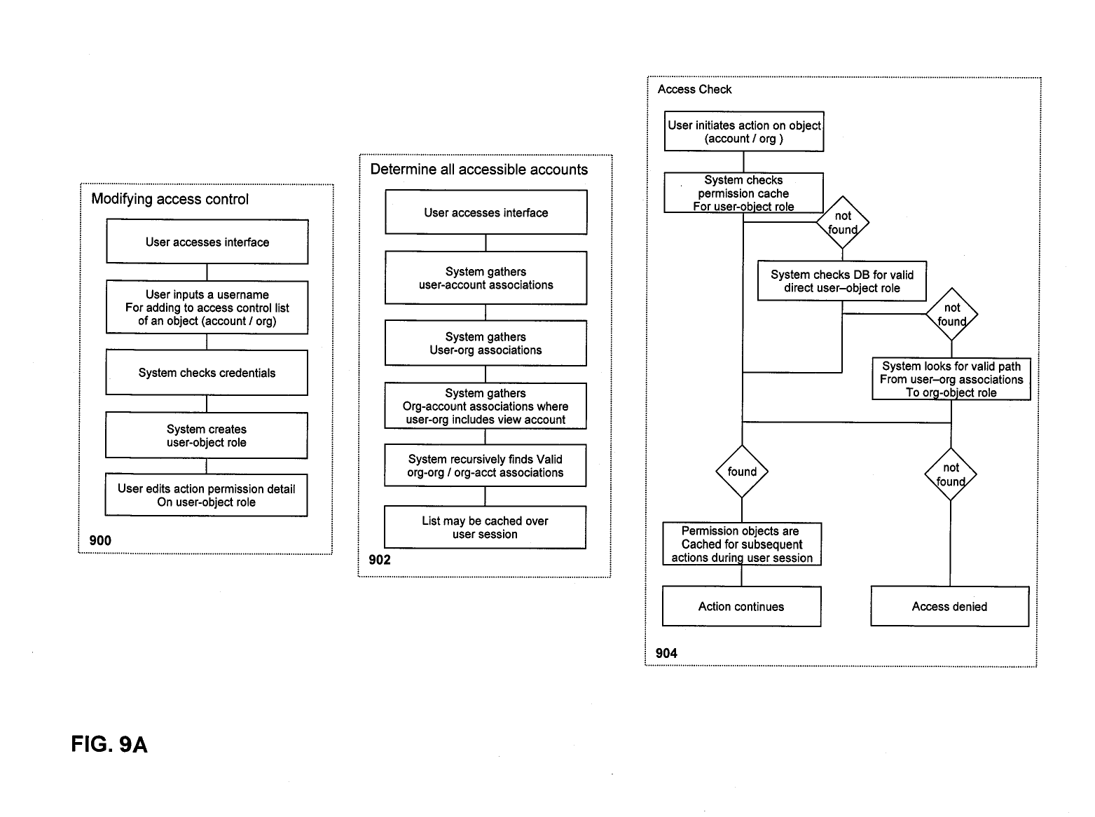

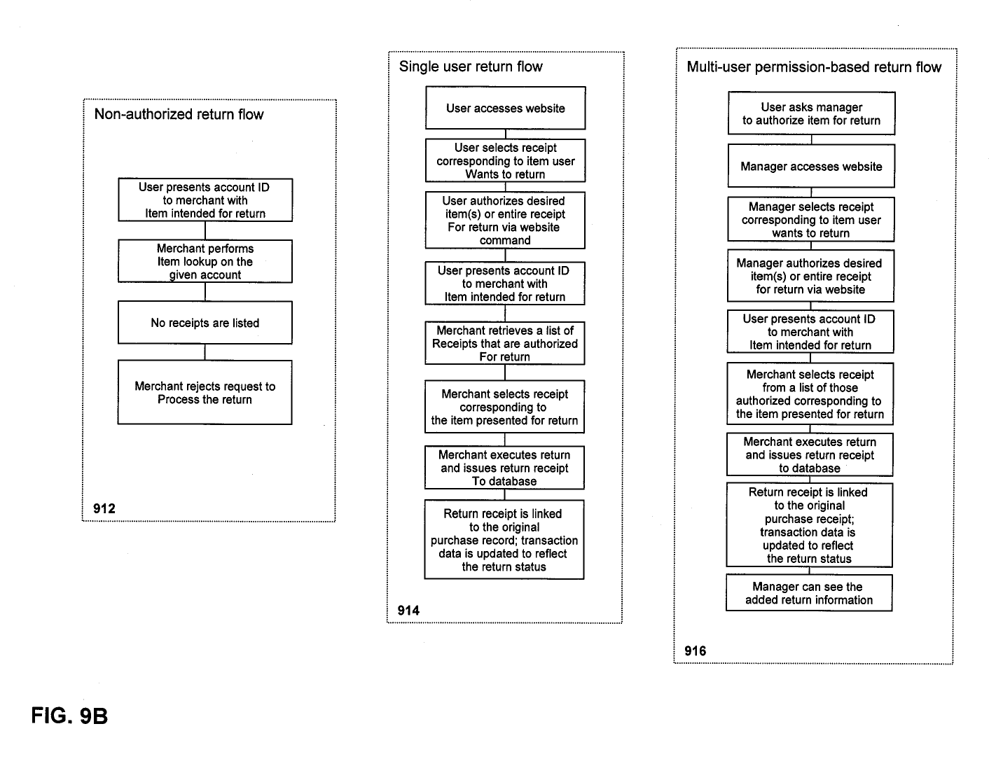

As noted before, the system provides permissions to be attributed with accounts. Different permission levels provide different levels of authorization for access to data and commands for an account. A user can request functions that operate on a particular record or within an account according to a permission level assigned to the account and/or him. Associations among accounts, users and other data elements can be established. FIG. 9A, shows process 900 which shows exemplary processes in modifying access to an account.

In modifying access control in process 900, the account creator/user accesses website GUI. Next, he can view transaction accounts associated with his user account. An authorized user may provide a username or user ID to the system, which identifies a user account that is to be associated with a selected transaction account. The system may create an association object relating the specified user to the specified account and populate this object with any specified permissions. Alternatively, an unassociated user may specify an account ID and possibly an account secret and have the system create an association object between the requesting user and the specified account. Instead of (or in addition to) granting access permission to the account, a notification may be sent to a user of the account who has manager permissions. This managing user may review the association request and assign permissions or delete the association at their discretion. The account secret is used to prevent malicious users from spamming accounts or gaining unauthorized access. The user IDs, account IDs and secrets may be passed between the users by email or other external means.

Process 902 shows exemplary processes in determining accessible accounts for a user. Process 904 shown exemplary processes in checking access privileges for an account.

As an account tracks transactions of a user, a set of accounts of related users may be grouped together. The related accounts may be organized and linked in various arrangements including a hierarchy or a linked data organization scheme. Related accounts may be organized and linked following organizational charts for a company. Primary accounts may be associated with secondary accounts. In a primary account, main data objects in the system, such as receipt records, are stored. Data relating to transactions, such as receipt data, gift package data, submission package data, and clipped coupon data, may be shared between two or more accounts. The data may be bundled together prior to sharing. The bundle of data may be connected with a sender's transaction account and a receiver's (third party's) account. The sender's account may be identified as the ‘primary account’ for the bundle.

As previously indicated, system accounts (transaction accounts) are provided, which are different from a user account (user login/profile). System accounts have a primary owner such as a user or an organization. System accounts can be used to store data for its user, including transaction and receipt data. In a system account, separate primary users may be associated with it. For example for a system account “Company”, the related Company may ‘own’ an account that it provisioned for its employee ‘Joe’. Joe is the primary user/purchaser because his purchases are recorded by that account; however Company is the owner of the account. The Company has full control over the account and Joe is provided with limited control. The embodiment is able to determine that Joe is making the purchases in the context of the Company rather than the system knowing only that an anonymous person purchased something in the context of the Company. These entities may be granted privileges pertaining to that account at the particular service level. Those users that act as account owners may assign permissions to other users where the permissions relate to the particular account. The system provides an account management interface on the website which allows account managers to add and remove users from the access control list. The interface also allows permissions to be assigned and revoked. Permissions may be assigned and enforced on many individual operations such as: view list of receipts, view receipt details, view gift records, create gift records, view expense submissions, create expense submissions, flag items for return, view access control lists, modify access control lists, and others.

Other user functions and account controls may be governed by controls provided to one or more users. An embodiment provides permissions to manage these controls. Permissions define allowable actions/accesses of an account or organization. In the context of merchants, as an example, a permission may define the ability to perform one or more actions on aspects of an organization, including an ability to: modify server access passkeys, add rebate records, add coupon records, upload public signature keys, check for duplicate entries, and manage record viewing templates. Such controls may be fully allowed, allowed with restrictions or denied, depending on a level of permission associated with the account or the user submitting the request. Such controls allow administration of data for the accounts or organizations. Another set of controls relate to accessing and updating an access control list for system accounts and organizations. For example, to add another user to the access control list, the managing user would need to provide to the system with the user identification number (user ID) of the new user. The user ID may be obtained by the managing user through means outside the operation of the system (e.g. via oral communications or an email from the user account owner).

A user may initiate a request to the system to be included in an access control list for an entity (e.g. account or organization). Permissions may be bundled for appropriate roles. For example, an administrator may have a suite of permissions tailored for that role. Since each action can individually be allowed/disallowed, certain action permissions may be grouped together with other action permissions. For example, an ‘accountant role’ may be defined to permit viewing of receipts and acceptance or denial of expenses, while not providing access to other functions (e.g. access management functions and ‘flag for return/approval’ functions). Also, an ‘administrator role’ may grant viewing access to a control list and modification privileges to an access control list while not providing access to other functions.

In the system, a role is a data object that can have permissions associated with it. The system stores a class of data objects that references a user and an account and records a list of permissions that the user has relating to the account. When a user initiates a request to the system to perform an action [on data] for an account, the system examines its database for an entry relating to the user and the account, and then the system examines the associated permissions. If the request is permissible, the request is allowed to continue. If the request is not permissible, a denial message is provided to the user. Actions that are denied may be logged noting the user, time, and action details. This log may be available to the account owner and to the system administrators for security purposes.

For permissions for organizations, the system has links and objects in its database that relate users to organizations. These links and objects provide permissions and roles that user(s) have for that organization. Accounts may be controlled by organizations. Users inherit permissions from the organizations allowing them to access the accounts. For example, a business may register for a number of accounts. That organization would have total control of the account because it owns the account. Specific users within that organization may be provided with different permissions, such as: view organization's receipt records, manage organization's account's access control list, modify organization profile, modify organization's access control list, and register new account. These organization permissions provide granular access control of various functions for the organization and the accounts belonging to the organization.

When a user submits a request to perform a function in the system, the system examines for the existence of a direct relationship and a permission level between the user and the related account or organization. The system also checks relations between users and organizations, where the user has inherited permissions (e.g. permission to modify an organization's accounts) and where the organization has permissions relating to the account being accessed. Use of permissions allows for a third party to implement changes to the data of an account. Permissions control can be provided for different functions, including expense claim processing and return processing.

Further detail is now provided on three exemplary returns outcomes of an embodiment. In FIG. 9B, flow chart 912 shows processes executed when an un-authorized return is attempted and denied. First, a user presents an account identification number to a merchant with the item for return. Next, a merchant performs an item lookup on the given account. At this point, the merchant cannot locate a record for the return and so the return request is rejected.

Flow chart 914 shows processes executed for a single user return request. A user selects a receipt corresponding to the item that the user wants to return. Next, the user authorizes desired item(s) or the entire receipt for return. Next, the user presents an account ID to the merchant with the item intended for return. Next, the merchant accesses the server to retrieve a list of authorized receipts for the account. Next, the merchant selects the receipt from the list corresponding to the item presented for return. Next, the merchant executes the return and issues a return receipt that is stored in the database. Next, the return receipt is linked to the original purchase record and the transaction data is updated to reflect the return status.

Flow chart 916 shows processes executed for a multi-user permission-based return. Therein, multiple user types access server 110. First, the user asks his manager to authorize an item for return. The manager accesses the system and selects the receipt corresponding to the item. The manager may then authorize desired item(s) or an entire receipt for return through the system. Next, the user presents an account ID to the merchant with the item intended for return. Next, the merchant selects the receipt from a list of those authorized corresponding to the item presented for return. Next, the merchant executes the return and issues the return receipt to the database. Next, the return receipt is linked to the original purchase record and the transaction data is updated to reflect the return status. The manager can then see the added return information.

Now, further detail on relationships among entities (users, accounts, item, organizations, etc.) is provided. These relationships are embodied in datastructures provided in database 116 (FIG. 2) for an embodiment via links among fields in tables within the database.

Referring to FIGS. 10A-10C, exemplary relationships between user classes are shown. The legend shows diagrammatically how elements are related to other elements. In FIG. 10A, relationships of a user are shown. A user entity identifies a person registered with the system. These user objects hold usernames, passwords and other user account information (not to be confused with system accounts). Sub-classes have relevant information according to user type. Individual users may belong to multiple sub-categories. These sub-classes represent profile information for the person as it pertains to the role the person has as a standalone user or within an organization. Profile information may include fields such as date of birth, gender, address, job position, employer, phone-number, email, and the related organization.

Referring to FIG. 10B, exemplary relationships between organization classes are shown. Organizations registered with the system may have multiple sub-profiles relating to different subclasses of organizations. Organizations may be related to a parent organization, allowing sub-grouping of organizations. For example, merchant head offices can be defined as an organization and the different locations of the merchant can be defined as registered merchant organizations with a reference to the head office organization as the parent. Another instance where this would be useful is for a head office for a business to be a separate entity from possible regional branches or departments within the main entity. Primarily, this allows different profile information to be stored for each location. It also allows accounts and permissions to be grouped to help ease their management within the system.

Referring to FIG. 10C, relationships among accounts and receipts are shown. Receipts are associated with accounts (referred to as ‘system accounts’, ‘transaction accounts’, or simply ‘accounts’). Identification data relating to multiple cards may be used to identify an account. Note that card objects may represent loyalty, bankcards, email addresses, phone numbers, or other non-card based identification data. With the card identifier and account ID, the card data object may contain the card type, card expiry, and other data. Transaction information (e.g. receipt data) may be distributed amongst multiple objects of different classes. The main information about a receipt is stored in a receipt object. Digital signature information may be stored as a separate object possibly in a separate location. Each receipt line item is a separate object handling item quantity, line total, and item details. As previously mentioned, since receipt line item information is relatively static amongst multiple transactions by multiple purchasers at a single merchant, item description, price, product code, and other information may be stored separately as common item details and then referenced by each corresponding receipt line item. Receipts may also track and index other composite fields of data such as payment information, which may be stored as a separate table. Multiple payment records can be recorded for each receipt, and users can easily sort transactions based on payment type. Information like varying fields, such as tax, receipt subtotals, custom fields defined by merchants, and other information not necessary to be indexed, may be stored in a single data field either with the receipt data or in an auxiliary location. The detail field can be parsed and formatted at display time. Certain details such as product serial number and coupon information for line items may be stored in the same way.

Referring to FIG. 10D, relationships between users, organizations, and accounts are illustrated, where rights to perform functions within the system are governed by permissions. Organizations and users are associated with accounts and have specific permissions. Users can have general permissions regarding organization functions and accounts related to organizations. Additionally, an organization can be granted permissions to perform functions on another organization's behalf. An example of this would be a registered POS software developer having permissions to manage receipt templates or pass keys of a number of merchant customers. The developer organization would give permission for employees to manage those organizations that the organization may manage, which are the merchant organizations. The role objects are used to relate the entities and record permissions. Permissions may be stored using one or more series of bit fields where each action has a specific bit flag that can be true or false.

Referring to FIG. 10E, relationships among receipts and bundles of receipts are shown. Receipts may be organized into groups/bundles (e.g. folders). A bundle of objects may hold bundle name, create date, annotations, account identifier, bundle identifier, and other data. Bundle element objects may hold a bundle identifier, receipt identifier, and possibly a receipt line item identifier. The folders may be submitted for reimbursement, sent as gifts, or forwarded to other accounts for other users/organizations to view. This figure also shows the relation between information about a return and the original transaction records. Transfers of receipts between accounts are also tracked with related information such as the user initiating the transfer, a transfer date, and others.

Referring to FIG. 10F, merchants may belong to multiple types of industry such as hospitality, food, fast food, restaurant, coffee shop, gas, rental, car park, retail, grocery, electronics, etc., which represent the main groups by which the user may filter receipts lists. Merchants also have related security key information and receipt view templates. Merchants may upload coupon information but this functionality is not restricted to merchants.

Referring to FIG. 10G, organizations track rebates and coupons, which can ultimately be associated with an account and a user.

Referring to FIG. 10H, an organization and/or user may both have associations to an account, which also tracks related receipts and folders which can be forwarded as gifts, expense submissions, etc. to other accounts.

Now further detail is provided on graphic outputs of an embodiment. Views for records in the receipt may be customized. The amount of information provided to the viewer may be customized depending on access provided to the requesting entity. For example, a merchant may have access to more fields for a record than a user. Different view layouts may be provided for different users in viewing templates. The structure of the visual display of a receipt may be stored separately from the information contained in the receipt. A merchant may add custom messages to the receipt view as part of its viewing template for users. Multiple viewing templates may be provided. Templates for a merchant location may be inherited from the parent merchant entity. A particular template may be selected depending on criteria of the requesting entities. For example, a receipt may request a particular template be used or different viewing templates may be provided based on the transaction date of the record. Templates may be written in a template language such as PHP or Twig and the rendered content may be in HTML and may include images and hyperlinks.

FIG. 11 provides an annotated exemplary rendering of receipt data using a template designed to mimic a printed receipt.

An embodiment has a facility of providing downloaded local transaction records. The downloaded data may be stored in a number of formats such as, YAML or a YAML-like format, XML, an extended XML digital receipt standard, a formatted plain text document, a formatted and styled HTML document, or with other previously downloaded receipts in a database. The document may contain information about the transaction and any subsequent logged uses of that information such as return records, gift receipts, (expense) submissions, and rebates. Digital signatures may be stored to facilitate authentication of documents offline. A certificate authority may sign a certificate. The document may contain (recent) modification times as part of the information recorded for gifting, returns etc. The user of the downloaded data has access to a function where they send the server the unique transaction identifier (account ID and transaction time) and get a server response containing the most recent update time as stored in the logs or information for that transaction. The user would be able to compare the date on the document to the date returned by the server to determine whether any updates were made since the document was downloaded. Alternatively, the server can perform the comparison to maintain a higher level of information privacy. These offline documents may be read by a user's software as an alternative to the website interface. The software may periodically check timestamps against the servers to maintain currency of the downloaded transaction data. If authorized, the updated data may be downloaded or the software may simply inform the user that the information may be out of date.

As an addition regarding access restrictions, an authorized user may have the system generate a special access URL for a particular receipt. The user may then distribute this URL or keep it as a bookmark for personal reference. As long as it is valid, the URL would be able to bypass any other access restrictions and allow the user to see the transaction history relating to the receipt associated with that URL. The user may revoke the URL if they feel it has fallen into undesired hands. The URL parameters could consist of an account ID and transaction time in order to refer to the correct transaction and also include a sufficiently large random key to prevent unauthorized access. The random key should be treated as a secret. A unique ID may also be generated in place of using the transaction identifier (account ID, time) in order to hide those details.

It will be appreciated that the modules, processes and other applications in the embodiments can be implemented using known programming techniques, languages and algorithms. The titles of the modules are provided as a convenience to provide labels and assign functions to certain modules. It is not required that each module perform only its functions as described above. As such, specific functionalities for each application may be moved between applications or separated into different applications. Modules may be contained within other modules. Different signaling techniques may be used to communicate information between applications using known programming techniques. Known data storage, access and update algorithms allow data to be shared between applications.

As used herein, the wording “and/or” is intended to represent an inclusive-or. That is, “X and/or Y” is intended to mean X or Y or both.

The present embodiment is defined by the claims appended hereto, with the foregoing description being merely illustrative of embodiments of the present disclosure. Those of ordinary skill may envisage certain modifications to the foregoing embodiments, which although not explicitly discussed herein, do not depart from the scope of the disclosure, as defined by the appended claims.

1. A database system for processing a transaction record of a transaction between a merchant and a user, said system comprising:
a database for storing and updating
an account record containing
account data associated with said user; and
transaction data; and
a plurality of coupon records;
a server for
providing update instructions for said account record to said database;
communicating with a first terminal associated with said merchant to process said account record;
building said transaction record for said database using data relating to said transaction provided from said first terminal, said transaction record containing information relating to said transaction, said merchant and said customer;
associating said transaction record with said transaction data in said account record;
providing data relating to a selection of coupon records from said plurality of coupon records to said first terminal during a session relating to said transaction; and
providing access to said account record to a requesting entity upon verification of access rights of said requesting entity to access said account record.

2. The database system for processing a transaction record of a transaction between a merchant and a user as claimed in claim 1, wherein said data relating to said selection of coupon records is provided to said first terminal upon a request received from said first terminal.

3. The database system for processing a transaction record of a transaction between a merchant and a user as claimed in claim 2, wherein said server further:
analyzes said plurality of coupon records and said transaction in said database to identify said selection of coupon records; and
provides said data relating to said selection of coupon records to said first terminal for presentation in a user interface on said first terminal.

4. The database system for processing a transaction record of a transaction between a merchant and a user as claimed in claim 1, wherein:
said plurality of coupon records relate to a plurality of products or services from a plurality of merchants; and
said server further
updates said transaction record when a selected coupon from said selection of coupon records is applied against said transaction to reflect a value of said selected coupon against said transaction;
updates data in said database relating to said selected coupon to reflect application of said selected coupon against said transaction; and
analyzes said plurality of coupon records to provide data relating to coupons of said plurality of coupon records that have been applied against transactions processed at said merchant.

5. The database system for processing a transaction record of a transaction between a merchant and a user as claimed in claim 4, wherein said server further:
initiates a rebate process to process a credit value to said account data when a rebate transaction has been applied against said account.

6. The database system for processing a transaction record of a transaction between a merchant and a user as claimed in claim 5, wherein said rebate process:
updates said transaction record when said rebate transaction has been completed to apply said credit value against said transaction record; and
updates data in said database relating to said rebate transaction to reflect application of said rebate transaction against said account data.

7. The database system for processing a transaction record of a transaction between a merchant and a user as claimed in claim 1, wherein said transaction record includes a version code to track a transaction version for said transaction.

8. The database system for processing a transaction record of a transaction between a merchant and a user as claimed in claim 1, wherein a copy of data associated with a receipt may be downloaded from said server for comparison with the server data.

9. The database system for processing a transaction record of a transaction between a merchant and a user as claimed in claim 1, wherein said server further provides access to said transaction record in said database:
to a second terminal when said second terminal provides authentication information about said user and said server authenticates said account record against said user; and
to said first terminal when said merchant has been authenticated for access said transaction record.

10. The database system for processing a transaction record of a transaction between a merchant and a user as claimed in claim 1, wherein:
said transaction is a purchase of an item by said customer from said merchant; and
said server updates said transaction record with a change of status of said record when an authorized change request is received from said terminal.

11. The database system for processing a transaction record of a transaction between a merchant and a user as claimed in claim 5, wherein:
said change of status is a return request of said item by said user to said merchant; and
upon confirmation of completion of said return request said record is updated to indicate that said item has been returned to said merchant.

12. The database system for processing a transaction record of a transaction between a merchant and a user as claimed in claim 11, wherein said server further:
processes a request for generating and sending a notification relating to said account record to an entity, said notification being sent upon satisfaction of a trigger condition for its transmission.

13. The database system for processing a transaction record of a transaction between a merchant and a user as claimed in claim 1, wherein:
said server further updates said transaction record to indicate that said transaction is a gift to a third party upon receiving a gift request relating to said transaction from a terminal connected to said server;
said gift request associates said transaction with a second user having a second account record in said database; and
said server updates said transaction record to link said gift request between said account record and said second account record.

14. The database system for processing a transaction record of a transaction between a merchant and a user as claimed in claim 9, wherein said server further:
accesses said database and collects records relating to said account upon receiving a request from a requesting terminal; and
transmits said records relating to said account to said requesting terminal.

16. The database system for processing a transaction record of a transaction between a merchant and a user as claimed in claim 1, wherein said server further:
updates said transaction record to indicate that said transaction is an expense submission for processing by a third party upon receiving an expense submission request relating to said transaction from a terminal connected to said server;
creates an expense submission record relating to said transaction record and stores said expense submission record in said database; and
updates a status field of said transaction record and said expense submission record upon receiving an update from said third party regarding a status of processing of said expense submission.

17. The database system for processing a transaction record of a transaction between a merchant and a user as claimed in claim 15, wherein:
access to data and transactions relating to said account is restricted by a password.

18. The database system for processing a transaction record of a transaction between a merchant and a user as claimed in claim 15, wherein:
said database further stores and updates data relating to a merchant account associated with merchant; and
said server further
receives a request from a terminal associated with said merchant relating to said merchant account;
determines whether said request from said merchant is authentic; and
if said request from said merchant is authentic, then transmits said merchant records to said terminal associated with said merchant.
